(19) United States
(12) Patent Application Publication
(10) Pub. No.: US 2026/0156696 A1
(43) Pub. Date: Jun. 4, 2026

(54) COMMUNICATION APPARATUS, CONTROL METHOD THEREOF, AND COMPUTER-READABLE STORAGE MEDIUM STORING A PROGRAM

(71) Applicant: CANON KABUSHIKI KAISHA, Tokyo (JP)

(72) Inventor: Ryuji Nagahara, Kanagawa (JP)

(21) Appl. No.: 19/395,237

(22) Filed: Nov. 20, 2025

(30) Foreign Application Priority Data
Nov. 29, 2024 (JP) 2024-208886

(51) Int. Cl. H04W 76/14; H04W 12/08; H04W 84/12

(52) U.S. Cl. CPC H04W 76/14; H04W 12/08; H04W 84/12

(57) ABSTRACT

A communication apparatus including: an infrastructure connection unit configured to make an infrastructure connection with an external device through an external access point; a direct connection unit configured to make a direct connection with an external device without going through an external access point; a first obtainment unit configured to obtain information pertaining to a security mode used in the infrastructure connection made by the infrastructure connection unit; and a control unit configured to control the direct connection unit to make the direct connection based on the information pertaining to the security mode obtained by the first obtainment unit.

### BACKGROUND

### Field of the Technology

The present disclosure relates to a communication apparatus, a control method thereof, and a computer-readable storage medium storing a program.

### Description of the Related Art

With the increase in the amount of data communicated in recent years, the development of communication technologies such as wireless Local Area Network (LAN) and the like is moving forward. The Institute of Electrical and Electronic Engineers (IEEE) 802.11 standard series is known as a major wireless LAN communication standard. The IEEE 802.11 standard series includes IEEE 802.11a/b/g/n/ac/ax standards and the like. For example, IEEE 802.11ax, which is the newest standard, standardizes a technique for using Orthogonal Frequency Division Multiple Access (OFDMA) to provide high peak throughput of up to 9.6 gigabits per second (Gbps) and improve communication speeds under congested conditions. “OFDMA” is an acronym for “Orthogonal Frequency-Division Multiple Access”.

Meanwhile, the Wi-Fi Alliance has formulated programs for authenticating wireless LAN devices. For example, the WFD standard has been formulated, which specifies procedures for exchanging (sharing) communication parameters among wireless LAN stations (STAs) to establish communication links between the STAs without going through an access point (AP). WFD is an acronym for “Wi-Fi Direct” (registered trademark).

The Wi-Fi Aware standard, which is a standard for searching for services provided by devices, has also been formulated. For example, Japanese Patent Laid-Open No. 2019-201427 describes detecting a communication terminal using the provisions set forth by the Wi-Fi Aware standard.

### SUMMARY

The present disclosure provides a technique for improving convenience when a communication apparatus makes a direct connection with an external device.

The present disclosure in one aspect provides a communication apparatus comprising: at least one memory and at least one processor which function as: an infrastructure connection unit configured to make an infrastructure connection with an external device through an external access point; a direct connection unit configured to make a direct connection with an external device without going through an external access point; a first obtainment unit configured to obtain information pertaining to a security mode used in the infrastructure connection made by the infrastructure connection unit; and a control unit configured to control the direct connection unit to make the direct connection based on the information pertaining to the security mode obtained by the first obtainment unit, wherein connection processing for the direct connection includes first connection processing corresponding to a first security mode and second connection processing corresponding to a second security mode having a security level higher than a security level of the first security mode, and the control unit controls the direct connection unit to perform one of the first connection processing and the second connection processing based on the information pertaining to the security mode obtained by the first obtainment unit.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a diagram illustrating an example of the configuration of a system.

FIGS. 2A and 2B are diagrams illustrating an example of the configuration of an MFP.

FIGS. 3A to 3C are diagrams illustrating screens displayed in a console unit of the MFP.

FIGS. 4A and 4B are diagrams illustrating the configuration of a mobile terminal device.

FIG. 5 is a schematic diagram illustrating the configuration of an access point.

FIG. 6 is a sequence chart illustrating connection processing in the WFD standard.

FIG. 7 is a sequence chart illustrating connection processing in the WFD standard.

FIGS. 8A to 8C are diagrams illustrating screens displayed in the console unit of the MFP.

FIGS. 9A to 9G are diagrams illustrating screens displayed in the console unit of the MFP.

FIGS. 10A to 10C are diagrams illustrating screens displayed in the console unit of the MFP.

FIGS. 11A and 11B are flowcharts illustrating processing executed by the MFP.

FIGS. 12A and 12B are flowcharts illustrating processing executed by the MFP.

FIGS. 13A and 13B are flowcharts illustrating processing executed by the MFP.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

Incidentally, as technology in which a communication apparatus directly connects to an external device without going through an external access point continues to spread, it is desirable to improve the convenience when the communication apparatus makes a direct connection with the external device.

### First Embodiment

### System Configuration

FIG. 1 illustrates an example of the configuration of a system according to the present embodiment. In one example, this system is a wireless communication system in which a plurality of communication apparatuses can communicate with each other wirelessly. In the example illustrated in FIG. 1, a mobile terminal device 104 and an MFP 100 serving as communication apparatuses, an AP 101 serving as an access point, a DHCP server 103, a DNS server 105, and a network 110 are provided. The mobile terminal device 104 is a device having a wireless communication function that uses wireless LAN or the like. “Wireless LAN” may be called “WLAN” hereinafter. The mobile terminal device 104 may be a personal information terminal such as a Personal Digital Assistant (PDA), a mobile phone (a smartphone), a digital camera, a personal computer, or the like.

The MFP 100 is a printing device having a printing function, and may further have a reading function (a scanner), a fax function, a telephone function, and the like. The MFP 100 according to the present embodiment also has a communication function that enables wireless communication with the mobile terminal device 104. Although the present embodiment describes a case where the MFP 100 is used as an example, the configuration is not limited thereto. For example, a scanner device, a projector, a mobile terminal, a smartphone, a laptop PC, a tablet terminal, a PDA, a digital camera, a music playback device, a television, a smart speaker, or the like, which has a communication function, may be used instead of the MFP 100. Note that “MFP” is an acronym for “Multi Function Peripheral”.

The AP 101 is provided separate from (outside) the mobile terminal device 104 and the MFP 100, and functions as a WLAN base station device. A communication apparatus having a WLAN communication function can communicate in WLAN infrastructure mode via the AP 101. Note that access points may be called “APs” hereinafter. Infrastructure mode may also be called “wireless infrastructure mode”. The AP 101 communicates wirelessly with a communication apparatus that has permitted (authenticated) a connection to itself, and relays wireless communication between that communication apparatus and other communication apparatuses. The AP 101 can, for example, be connected to a wired communication network, and can relay communication between a communication apparatus connected to that wired communication network and another communication apparatus wirelessly connected to the AP 101.

The DHCP server 103 connects to the MFP 100 via the AP 101 and the network 110, and provides services to the MFP 100 by responding to requests from the MFP 100. Although FIG. 1 illustrates a configuration in which the DHCP server 103 is connected as a device separate from the AP 101, the configuration may be such that the AP 101 has DHCP server functionality. The DNS server 105 is connected to the MFP 100, the mobile terminal device 104, and the like via the AP 101 and the network 110, and provides services for name resolution by responding to requests from the MFP 100, the mobile terminal device 104, and the like. Here, the network 110 may be the Internet, or may be a private network in a business, a mobile phone network, or the like.

### External Configuration of MFP

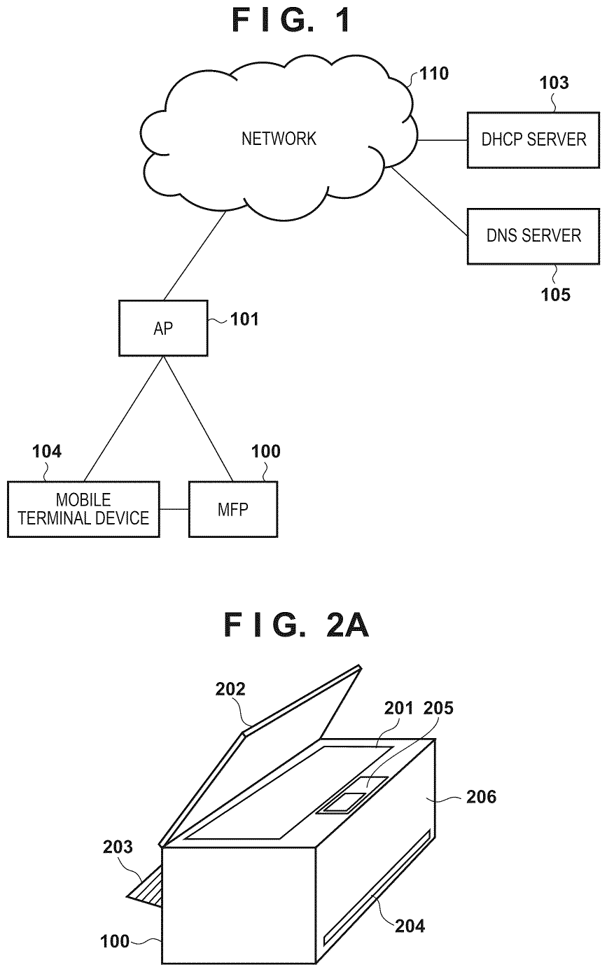

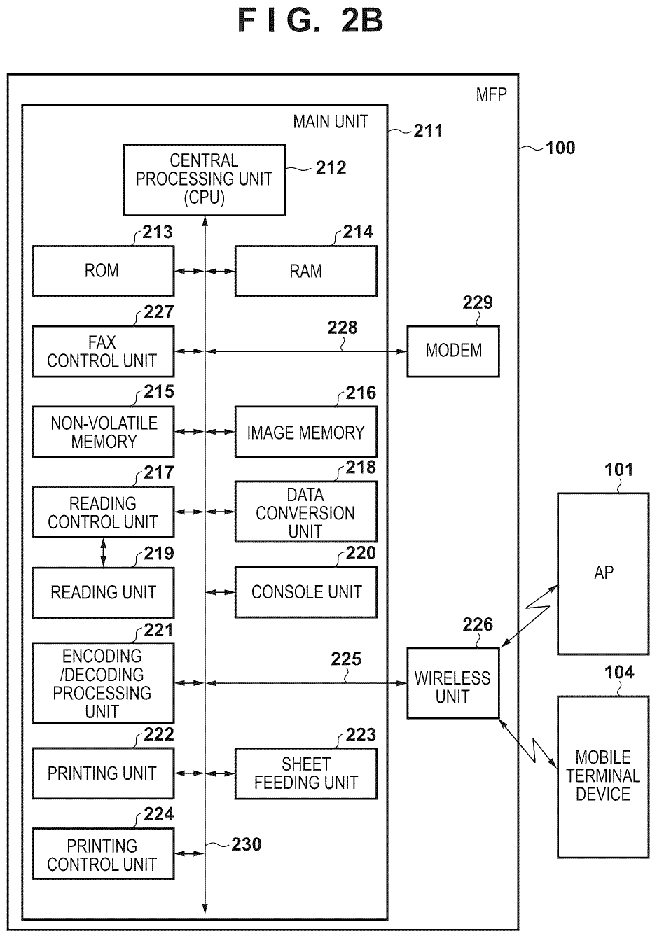

FIG. 2A illustrates an example of the external configuration of the MFP 100. The MFP 100 includes a document platform 201, a document cover 202, a printing paper insertion port 203, a printing paper discharge port 204, and a console unit 205, for example. The document platform 201 is a platform for placing a document to be read. The document cover 202 is a cover for securing a document placed on the document platform 201, and for ensuring that light from a light source that illuminates the document does not escape to the exterior when the document is being read. The printing paper insertion port 203 is an insertion port in which various sizes of sheets can be set. The printing paper discharge port 204 is a discharge port for discharging a sheet which has been printed onto. Paper set in the printing paper insertion port 203 is conveyed one sheet at a time to a printing unit, where the sheet is printed onto and then discharged from the printing paper discharge port 204. The console unit 205 is configured including keys such as text input keys, a cursor key, an OK key, a cancel key, and the like, as well as LEDs, an LCD, and the like, and is configured such that a user can launch the various functions of the MFP, manipulate various settings, and the like. The console unit 205 may also be configured including a touchscreen. The MFP 100 has a WLAN wireless communication function and therefore is configured also including a wireless communication antenna 206 for that wireless communication, although the antenna 206 is not necessarily visible from the exterior. Like the mobile terminal device 104, the MFP 100 can communicate wirelessly over the WLAN in frequency bands such as the 2.4 GHz band, the 5 GHz band, the 6 GHz band, or the like.

### MFP Configuration

FIG. 2B illustrates an example of the configuration of the MFP 100. The MFP 100 is configured including a main unit 211 that performs main control of the device itself, and a wireless unit 226, which is a single communication module that performs WLAN communication using at least one common antenna. The MFP 100 is also configured including a modem 229 for wired communication, for example. The main unit 211 is configured including, for example, a central processing unit (CPU) 212, a ROM 213, a RAM 214, a non-volatile memory 215, an image memory 216, a reading control unit 217, a data conversion unit 218, a reading unit 219, and an encoding/decoding processing unit 221. The main unit 211 is simply a unit including function blocks other than the wireless unit 226 and the modem 229. The main unit 211 also includes, for example, a printing unit 222, a sheet feeding unit 223, a printing control unit 224, and a console unit 220. The function units in the main unit 211 are connected to each other by a system bus 230 managed by the CPU 212. Additionally, the main unit 211 and the wireless unit 226 are connected by a dedicated bus 225, for example, and the main unit 211 and the modem 229 are connected by a bus 228, for example.

The CPU 212 is a system control unit including at least one processor, and controls the MFP 100 as a whole. The processing by the MFP 100 described below is implemented by the CPU 212 executing programs stored in the ROM 213, for example. Note that dedicated hardware for each process may be provided. The ROM 213 stores control programs executed by the CPU 212, embedded OS programs, and the like. In the present embodiment, the CPU 212 performs software control such as scheduling, task switching, and the like by executing each control program stored in the ROM 213 under the management of an embedded OS, which is also stored in the ROM 213.

The RAM 214 is constituted by an SRAM or the like. The RAM 214 stores data such as program control variables, data such as setting values registered by the user and management data of the MFP 100, and the like. In addition, the RAM 214 can be used as various types of working buffers. The non-volatile memory 215 is constituted by a memory such as a flash memory, for example, and continues to store data even when the MFP 100 is turned off. The image memory 216 is constituted by a memory such as a DRAM. The image memory 216 stores image data received through the wireless unit 226, image data processed by the encoding/decoding processing unit 221, and the like. Note that the memory configuration of the MFP 100 is not limited to the configuration described above. The data conversion unit 218 analyzes data in various formats, converts image data into print data, and the like.

The reading control unit 217 controls the reading unit 219 (e.g., a contact-type image sensor (CIS)) to optically read a document placed on the document platform 201. The reading control unit 217 converts an image obtained by optically reading the document into electrical image data (an image signal) and outputs the image data. At this time, the reading control unit 217 may perform various types of image processing, such as binarization, half-tone processing, and the like before outputting the image data.

The console unit 220 is the console unit 205 described with reference to FIG. 2A, and displays items in a display under display control by the CPU 212, generates signals in response to accepting user operations, and the like.

The encoding/decoding processing unit 221 performs encoding processing, decoding processing, scaling processing, and the like on image data handled by the MFP 100 (JPEG, PNG, and the like).

The sheet feeding unit 223 holds sheets for printing. The sheet feeding unit 223 can supply sheets set therein under the control of the printing control unit 224. The sheet feeding unit 223 may include a plurality of sheet feeding units to hold a plurality of types of sheets in a single apparatus, and from which sheet feeding unit sheets are fed can be controlled by the printing control unit 224.

The printing control unit 224 applies various types of image processing, such as smoothing processing, print darkness correction processing, color correction, and the like, to the image data to be printed, and outputs the processed image data to the printing unit 222. The printing unit 222 is configured to be capable of executing ink jet printing processing, for example, so that ink supplied from an ink tank is ejected from a print head and an image is recorded on a recording medium such as paper. Note that the printing unit 222 may be configured to be capable of executing other types of printing processing, such as electrophotographic printing. The printing control unit 224 can also periodically read out information on the printing unit 222 and update status information and the like stored in the RAM 214, including the remaining amount of ink in the ink tank, the state of the print head, and the like.

The wireless unit 226 is a unit capable of providing a WLAN communication function, and is capable of providing functions equivalent to a combination with a WLAN unit 429 of the mobile terminal device 104, for example. In other words, according to the WLAN standard, the wireless unit 226 converts data into packets and sends the packets to other devices, and also restores packets from other external devices into the original data thereof and outputs the data to the CPU 212. The wireless unit 226 is capable of communicating as a station compliant with the IEEE 802.11 standard series. The wireless unit 226 is particularly capable of communicating as a station compliant with IEEE 802.11a/b/g/n/ac/ax. “Stations” may be called “STA” hereinafter.

The wireless unit 226 supports IEEE 802.11ax, i.e., Wi-Fi 6 (registered trademark), and is capable of processing compliant with IEEE 802.11ax. In other words, the MFP 100 is capable of either or both of processing as a STA that supports (is compliant with) OFDMA, and operations (processing) as an STA that supports (is compliant with) TWT. “OFDMA” is an acronym for “Orthogonal Frequency-Division Multiple Access”. “TWT” is an acronym for “Target Wake Time”. Supporting TWT means that the timing of data communication from a parent device to the STA is adjusted. The wireless unit 226 (the MFP 100) serving as the STA shifts the communication function to a sleep state when there is no need to stand by for signal reception. This makes it possible to suppress power consumption. The wireless unit 226 also supports Wi-Fi 6E (registered trademark). In other words, the wireless unit 226 is also capable of communicating in the 6 GHz band (5.925 GHz to 7.125 GHz). Unlike the 5 GHz band, the 6 GHz band does not have a band in which Dynamic Frequency Selection (DFS) is performed. As such, in communication in the 6 GHz band, communication will not be cut off due to DFS standby time, which can be expected to improve the communication. Although processing compliant with IEEE 802.11ax is assumed to be performed here, the mobile terminal device 104 and the MFP 100 may operate in compliance with other standards in the IEEE 802.11 series. For example, the operations may be compliant with IEEE 802.11be or a later standard.

Note that the mobile terminal device 104 and the MFP 100 are capable of P2P (WLAN) communication based on WFD, and the wireless unit 226 has a software access point (software AP) function or a group owner function. In other words, the wireless unit 226 is capable of constructing P2P communication networks, setting channels to use in P2P communication, and the like. WFD is assumed here to be based on a standard formulated by the Wi-Fi Alliance. The wireless unit 226 can also operate as a WFD client.

### MFP Console Unit

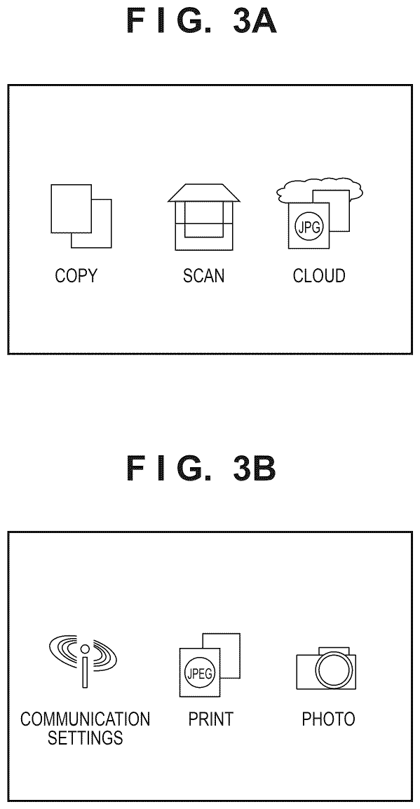

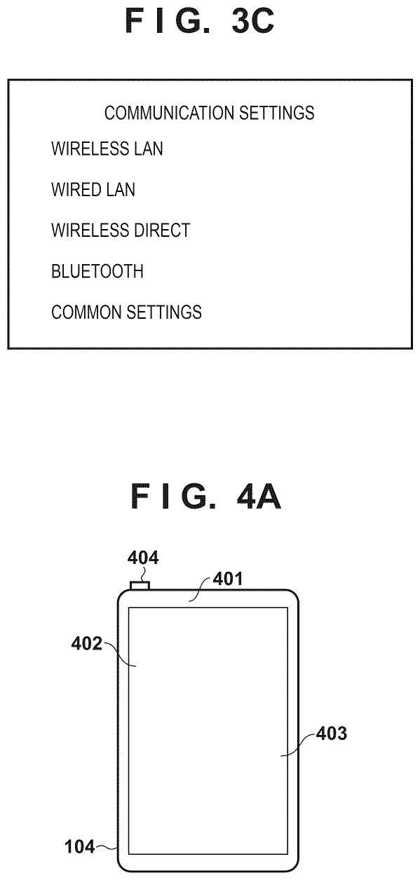

FIGS. 3A to 3C schematically illustrate examples of screens displayed on a display (a touchscreen) included in the console unit 220 of the MFP 100. FIG. 3A illustrates an example of a home screen displayed when the MFP 100 is turned on and operations such as printing, scanning, or the like are not underway (an “idle state” or a “standby state”). In FIG. 3A, display items indicating “Copy”, “Scan”, and “Cloud” (menu items) are displayed. “Cloud” is a menu item related to a cloud function that uses Internet communication. Settings in the MFP 100 can be made, the execution of functions can be started, and the like by operating keys, the touch panel, or the like to select one of the menu items. The MFP 100 can seamlessly display a screen different from that illustrated in FIG. 3A by accepting an operation of a key, the touch panel, or the like in the home screen illustrated in FIG. 3A.

FIG. 3B is an example of the display of another part of the home screen, and is a screen transitioned to in response to an operation for displaying another page of the home screen (an operation for sliding to the left or the right) being made in the state illustrated in FIG. 3A. In FIG. 3B, display items (menu items) indicating “Communication Settings”, “Print”, and “Photo” are displayed. When one of these menu items is selected, the function corresponding to the selected menu item, i.e., one of a printing function, a photo function, and communication settings, is executed.

FIG. 3C is an example of the display of a menu screen for the communication settings, displayed when “Communication Settings” has been selected in the screen illustrated in FIG. 3B. The communication settings menu screen is a network settings screen in which “Wireless LAN”, “Wired LAN”, “Wireless Direct”, “Bluetooth”, and “Common Settings” are displayed as menu items (options) in the communication settings menu screen. “Wireless LAN”, “Wired LAN”, and “Wireless Direct” are menu items for LAN settings, and settings such as wired connection settings, settings for enabling and disabling a wireless infrastructure mode, settings for enabling and disabling a P2P mode such as WFD and software AP mode, and the like can be set using these items. When the “Wireless LAN” item is selected and the wireless LAN is enabled by a user operation, wireless infrastructure mode is enabled. When the “Wireless Direct” item is selected and Wireless Direct is enabled by a user operation, the P2P (WLAN) mode is enabled. A common settings menu pertaining to each connection format is also displayed in this screen. Furthermore, the user can set the frequency band, frequency channel, and the like of the wireless LAN from this screen.

### External Configuration of Mobile Terminal Device

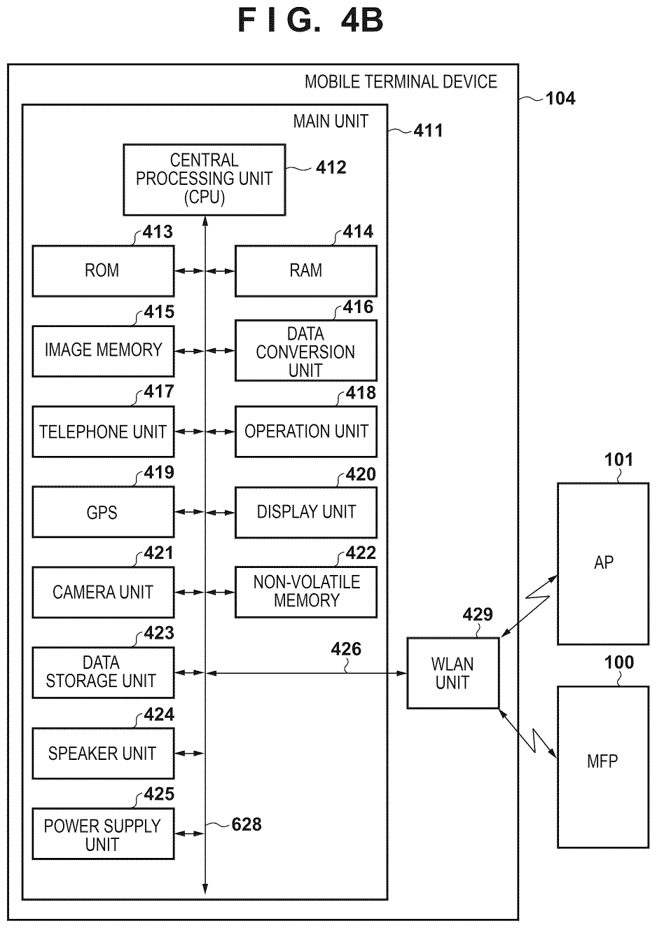

FIG. 4A is a diagram illustrating an example of the external configuration of the mobile terminal device 104. The present embodiment will describe a case where the mobile terminal device 104 is a typical smartphone, for example. Note that the mobile terminal device 104 is configured including a display unit 402, an operation unit 403, and a power key 404, for example. The display unit 402 is a display having a Liquid Crystal Display (LCD)-based display mechanism, for example. Note that the display unit 402 may display information using a Light Emitting Diode (LED) or the like, for example. The mobile terminal device 104 may also have a function for outputting information by audio in addition to or instead of the display unit 402. The operation unit 403 is configured including physical keys such as keys, buttons, and the like, a touch panel, and the like for detecting user operations. Note that in this example, the information display in the display unit 402 and the acceptance of user operations by the operation unit 403 are performed using a common touchscreen, and thus the display unit 402 and the operation unit 403 are implemented as a single device. In this case, for example, button icons or a software keyboard are displayed using a display function of the display unit 402, and the user touching those locations is detected using an operation reception function of the operation unit 403. Note that the display unit 402 and the operation unit 403 may be separate, and the hardware for display and the hardware for accepting operations may be provided individually. The power key 404 is a physical key for accepting user operations for turning the mobile terminal device 104 on or off.

The mobile terminal device 104 includes a WLAN unit 401, which provides WLAN communication functionality, but is not necessarily visible from the exterior. The WLAN unit 401 is configured to be capable of data (packet) communication in a WLAN system compliant with the IEEE 802.11 standard series (IEEE 802.11a/b/g/n/ac/ax and the like), for example. The WLAN unit 401 is also capable of communicating as an AP that supports Wi-Fi Agile Multiband (registered trademark). However, the configuration is not limited thereto, and the WLAN unit 401 may be capable of communication in a WLAN system compliant with another standard. This example assumes that the WLAN unit 401 is capable of communicating in the 2.4 GHz, 5 GHz, and 6 GHz frequency bands. The WLAN unit 401 is also assumed to be capable of communication based on WFD, communication using the software AP mode, communication using the wireless infrastructure mode, and the like. Operations performed in these modes will be described later.

### Configuration of Mobile Terminal Device

FIG. 4B illustrates an example of the configuration of the mobile terminal device 104. The mobile terminal device 104 includes a main unit 411 that performs main control of the device itself, and the WLAN unit 429, which performs WLAN communication, for example. The main unit 411 is simply a unit including function blocks other than the WLAN unit 429. The main unit 411 includes, for example, a CPU 412, a ROM 413, a RAM 414, an image memory 415, a data conversion unit 416, a telephone unit 417, a GPS 419, a camera unit 421, a non-volatile memory 422, a data storage unit 423, a speaker unit 424, and a power supply unit 425. Here, CPU is an acronym of “Central Processing Unit”, ROM is an acronym of “Read Only Memory”, RAM is an acronym of “Random Access Memory”, and GPS is an acronym of “Global Positioning System”. The mobile terminal device 104 also includes a display unit 420 and an operation unit 418. The function units in the main unit 411 are connected to each other by a system bus 628 managed by the CPU 412. Additionally, the main unit 411 and the WLAN unit 429 (the aforementioned WLAN unit 401) are connected, for example, by a dedicated bus 426.

The CPU 412 is a system control unit including at least one processor, and controls the mobile terminal device 104 as a whole. The processing by the mobile terminal device 104 described below is implemented by the CPU 412 executing programs stored in the ROM 413, for example. Note that dedicated hardware for each process may be provided. The ROM 413 stores control programs executed by the CPU 412, embedded operating system (OS) programs, and the like. In the present embodiment, the CPU 412 performs software control such as scheduling, task switching, and the like by executing each control program stored in the ROM 413 under the management of an embedded OS, which is also stored in the ROM 413.

The RAM 414 is constituted by a Static RAM (SRAM) or the like. The RAM 414 stores data such as program control variables, data such as setting values registered by the user and management data of the mobile terminal device 104, and the like. In addition, the RAM 414 can be used as various types of working buffers. The image memory 415 is constituted by a memory such as a Dynamic RAM (DRAM) or the like. The image memory 415 temporarily stores image data received through the WLAN unit 429, image data read out from the data storage unit 423, and the like for processing by the CPU 412. The non-volatile memory 422 is constituted by a memory such as a flash memory, for example, and continues to store data even when the mobile terminal device 104 is turned off. Note that the memory configuration of the mobile terminal device 104 is not limited to the configuration described above. For example, the image memory 415 and the RAM 414 may be implemented by the same memory, data may be backed up using the data storage unit 423, or the like. Additionally, although the present embodiment describes a DRAM as an example of the image memory 415, another storage medium such as a hard disk, a non-volatile memory, or the like may be used instead.

The data conversion unit 416 analyzes data in various formats, performs data conversion such as color conversion and image conversion, and the like. The telephone unit 417 controls a telephone line, and implements telephone communication by processing audio data input and output through the speaker unit 424. The GPS 419 receives radio waves transmitted from a satellite and obtains location information such as the current latitude, longitude, and the like of the mobile terminal device 104.

The camera unit 421 has a function for electronically recording and encoding an image input through a lens. The image data captured by the camera unit 421 is stored in the data storage unit 423. The speaker unit 424 performs control for implementing a function for inputting or outputting audio for the telephone function, other functions such as alarm notifications, and the like. The power supply unit 425 is a portable battery, for example, and controls the supply of power to the interior of the device. Power states include, for example, a “battery depleted state” in which there is no power remaining in the battery, a “power off state” in which the power key 404 has not been pressed, an “operating state” in which the battery is running normally, and a “power-saving state” in which the battery is operating but is in a power saving state.

The display unit 420 is the display unit 402 described with reference to FIG. 4A, and displays various types of input operations, the operating state and status of the MFP 100, and the like under the control of the CPU 412. The operation unit 418 is the operation unit 403 described with reference to FIG. 4A, and when a user operation is accepted, performs control such as generating an electrical signal corresponding to the operation, outputting the electrical signal to the CPU 412, and the like.

The mobile terminal device 104 performs wireless communication using the WLAN unit 429, and performs data communication with other devices such as the MFP 100. The WLAN unit 429 converts data into packets and sends the packets to other devices. The WLAN unit 429 also restores packets from other external devices into the original data and outputs the data to the CPU 412. The WLAN unit 429 is a unit for implementing communication compliant with each WLAN standard. The WLAN unit 429 can operate in at least two communication modes simultaneously, including wireless infrastructure mode and P2P (WLAN) mode. Note that the frequency bands used in these communication modes can be limited by the functions and performance of the hardware.

### Configuration of Access Point

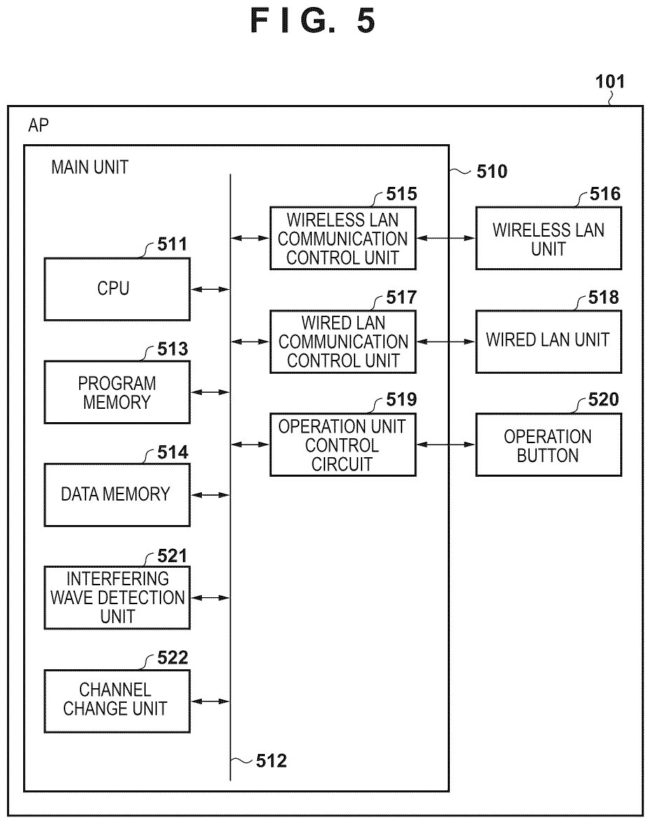

FIG. 5 is a block diagram illustrating the configuration of the AP 101 having a wireless LAN access point function. A main unit 510, which controls the AP 101, is configured including a wireless LAN unit 516, a wired LAN unit 518, and an operation button 520. The main unit 510 is simply a unit including function blocks other than the wireless LAN unit 516, the wired LAN unit 518, and the operation button 520.

A microprocessor-type CPU 511 disposed in the main unit 510 operates in accordance with a control program stored in a ROM-type program memory 513 and data in a RAM-type data memory 514, which are connected to the CPU 511 by an internal bus 512. The CPU 511 communicates with other communication terminal devices over a wireless LAN by controlling the wireless LAN unit 516 through a wireless LAN communication control unit 515. The CPU 511 also communicates with other communication terminal devices over a wired LAN by controlling the wired LAN unit 518 through a wired LAN communication control unit 517. The CPU 511 is capable of accepting operations made by a user manipulating the operation button 520, by controlling an operation unit control circuit 519. The CPU 511 includes at least one processor.

The AP 101 also includes an interference wave detection unit 521 and a channel changing unit 522. The interference wave detection unit 521 performs interference wave detection processing when communicating wirelessly in a band in which Dynamic Frequency Selection (DFS) is implemented. When communicating wirelessly in a band in which DFS is implemented, the channel changing unit 522 performs processing for changing the channel used when interference waves are detected, when it is necessary to immediately change to a free channel, and the like.

### P2P Communication Method

An overview of a P2P (WLAN) communication method for devices to wirelessly communicate directly with each other without traversing an external access point in WLAN communication will be given next. P2P (WLAN) communication can be implemented through a plurality of methods, e.g., the communication apparatus can support a plurality of modes for P2P (WLAN) communication and selectively execute P2P communication (WLAN) using one of the plurality of modes.

The following two modes are assumed as P2P modes.
Software AP Mode
Wi-fi Direct (WFD) Mode

A communication apparatus capable of P2P communication can be configured to support at least one of these modes. However, even a communication apparatus capable of P2P communication does not have to support all of these modes, and may be configured to support only some.

In a communication apparatus having a WFD communication function (e.g., the mobile terminal device 104), an application for implementing the communication function (in some cases, a dedicated application) is called in response to a user operation being accepted through the operation unit of the device. The communication apparatus can then display a screen of a user interface (UI) provided by the application to prompt the user to perform an operation, and then perform WFD communication based on the user operation accepted in response thereto.
Software AP Mode

In the software AP mode, the communication apparatus (e.g., the mobile terminal device 104) operates in the role of a client requesting various types of services. The other communication apparatus (e.g., the MFP 100) operates as a software AP capable of performing WLAN AP functions through software settings. Note that commands, parameters, and the like sent and received when establishing a wireless connection between the client and the software AP may be those specified by the Wi-Fi (registered trademark) standard, and will therefore not be described. The MFP 100 operating in software AP mode also determines a frequency band and a frequency channel as a parent station. Accordingly, the MFP 100 can select which frequency band to use from 2.4 GHz, 5 GHz, or 6 GHz, as well as which frequency channel to use in that frequency band. In the software AP mode, there is no negotiation for determining roles, and there is no need to comply with the WFD standard formulated by the Wi-Fi Alliance.
WFD Mode

In the present embodiment, the mobile terminal device 104 and the MFP 100 support functions disclosed as Wi-Fi Direct. “Wi-Fi Direct” is a function through which a device supporting Wi-Fi Direct can establish its own Wi-Fi network without the need for an Internet connection. Specifically, devices supporting Wi-Fi Direct, such as the mobile terminal device 104 and the MFP 100, can connect directly to each other even in an environment without an AP 101 or the like. The MFP 100 may be started so as to be fixed as the parent station for WFD mode (Autonomous Group Owner). Note that “Autonomous Group Owner” may be called “Auto GO” hereinafter. In this case, GO Negotiation processing for determining the role is unnecessary. Furthermore, in this case, the MFP 100 also determines the frequency band and the frequency channel to be used as the parent station. Accordingly, the MFP 100 can select which frequency band to use from 2.4 GHz, 5 GHz, or 6 GHz, as well as which frequency channel to use in that frequency band. Furthermore, in the WFD mode, the configuration may be such that GO Negotiation is performed to determine which device will operate as the group owner and which device will operate as the client.

### Wireless Infrastructure Mode

In wireless infrastructure mode, communication apparatuses that communicate with each other (e.g., the mobile terminal device 104 and the MFP 100) are connected to an external AP that manages the network (e.g., the AP 101), and the communication apparatuses communicate with each other through the AP. In other words, communication between the communication apparatuses is executed over a network constructed by an external AP. The mobile terminal device 104 and the MFP 100 both discover the AP 101, and by sending a connection request and connecting to the AP 101, those communication apparatuses can communicate in wireless infrastructure mode via the AP 101. Note that a plurality of communication apparatuses may be connected to individual separate APs. In this case, the communication apparatuses can communicate by data being transferred among the APs. The commands, parameters, and the like sent and received during communication between the communication apparatuses via the access points may be any specified by the Wi-Fi standard, and will therefore not be described. In this case, the AP 101 also determines the frequency band and the frequency channel. Accordingly, the AP 101 can select which frequency band to use from 2.4 GHz, 5 GHz, or 6 GHz, as well as which frequency channel to use in that frequency band.

The following will describe the WFD standard as having a method for a first standard and a method for a second standard different from the method for the first standard. In other words, in the WFD standard, a plurality of methods with different standard versions are present. The method for the second standard is a newer standard version than the method for the first standard. Here, the method for the first standard will be referred to as WFD R1 (Release 1), and the method for the second standard will be referred to as WFD R2 (Release 2). In order to establish a Wireless Direct connection (described later) between the MFP 100 and the mobile terminal device 104 through WFD, it is necessary to execute the connection processing in the WFD standard. The connection processing in the WFD standard includes first connection processing through a method according to the first standard and second connection processing through a method according to the second standard. Each instance of connection processing will be described hereinafter. WFD R1 and WFD R2 use different methods for searching for devices and sharing parameters. Note that in the present embodiment, “sharing parameters” includes at least one of sending and receiving (exchanging) parameters through communication between devices, and parameter information being recognized by devices through a user operation such as scanning a QR code (registered trademark).

### First Connection Processing by Method Using First Standard

The mobile terminal device 104 and the MFP 100 support functions disclosed as Wi-Fi Direct. “Wi-Fi Direct” is a function through which a device supporting Wi-Fi Direct can establish its own Wi-Fi network without the need for an Internet connection. Specifically, devices supporting Wi-Fi Direct, such as the mobile terminal device 104 and the MFP 100, can connect directly to each other even in an environment without an AP 101 or the like.

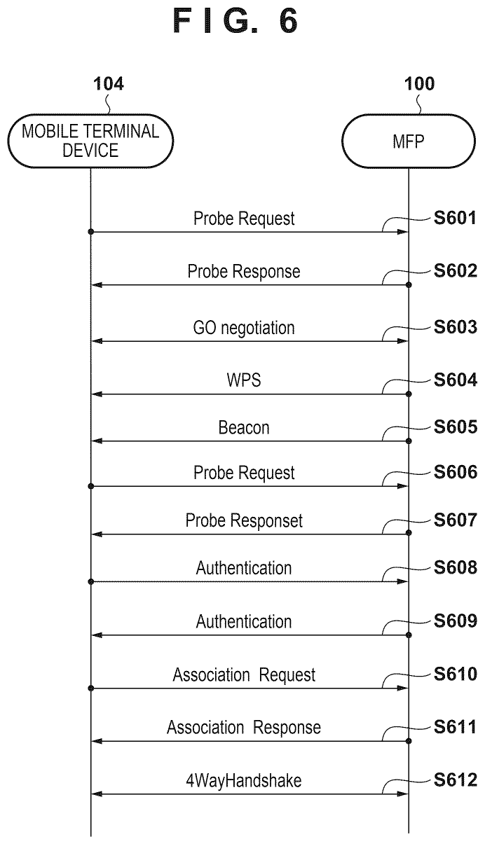

FIG. 6 is a sequence chart illustrating processing by which the mobile terminal device 104 and the MFP 100 connect in accordance with the WFD standard. A processing sequence for WFD R1 is illustrated here. Processing executed by each device in this sequence is implemented by the CPU of each device reading out various programs stored in a memory provided in that device, such as a ROM or the like, into a RAM and executing those programs.

For example, the processing of the sequence is started in the mobile terminal device 104 and the MFP 100 in response to receiving an instruction to start WFD from the user. Upon receiving the operation for starting WFD from the user, the mobile terminal device 104 and the MFP 100 search for a partner device by repeating a Listen state and a Search state. These states may be preceded by a period for scanning each channel. In the Listen state, for example, the device selects channel 1 in the 2.4 GHz band and stands by for a Probe Request frame from another communication apparatus. In the Search state, the device sends the Probe Request frame while switching the frequency channel (e.g., between channel 1, channel 6, and channel 11), and stands by for a Probe Response frame.

In step S601, the mobile terminal device 104 sends a Probe Request frame to search for a WFD communication apparatus. The partner device to be searched for is searched for by sending the Probe Request frame. It is assumed here that the communication apparatus performing the search is the mobile terminal device 104, and the partner device being searched for is the MFP 100. The Probe Request frame has a WFD attribute (P2P IE), which specifies that the target of the search is a WFD communication apparatus.

In step S602, upon receiving the Probe Request frame, the MFP 100 sends a Probe Response frame. The mobile terminal device 104 detects the MFP 100 that is the WFD communication partner (communication destination) by receiving the Probe Response frame sent by the MFP 100. Note that the Probe Request frame and the Probe Response frame include P2P IE, and may also include a Multi-Link element. The Multi-Link element may include communication parameters used for multi-link communication as specified in the IEEE 802.11be standard. Through this, a plurality of links can be set in a single connection procedure between the communication apparatuses. In this manner, in WFD R1, the presence of another communication apparatus can be detected using first search processing, which uses the Probe Request/Probe Response frames. The first search processing described above is a WFD R1 search sequence.

In step S603, the mobile terminal device 104 and the MFP 100 perform GO Negotiation processing. GO Negotiation processing is processing for determining which of the mobile terminal device 104 and the MFP 100 is the parent device. The channel to be used for direct wireless communication may be determined in the GO Negotiation. In the GO Negotiation processing, the mobile terminal device 104 and the MFP 100 send and receive GO Negotiation Request/GO Negotiation Response frames, which include an intent value indicating the degree to which the device intends to be the GO. The GO Negotiation Request/GO Negotiation Response frames determine the roles of P2P group owner (GO) and P2P client. The MFP 100 may be started so as to be fixed as the parent station (GO) for WFD mode (Autonomous Group Owner). In this case, GO Negotiation processing for determining the role is unnecessary. The MFP 100 may ensure it itself always operates as the GO, despite the GO Negotiation processing being executed, by setting the intent value for itself to a maximum of 15. Furthermore, in this case, the MFP 100 also determines the frequency band and the frequency channel to be used in direct wireless communication as the parent station. Accordingly, the MFP 100 can select the frequency band to use, namely 2.4 GHz or 5 GHz, as well as which frequency channel to use in that frequency band.

In step S604, the mobile terminal device 104 and the MFP 100 share communication parameters through Wi-Fi Protected Setup (WPS) processing. The communication parameters may include parameters used for wireless communication, such as Service Set Identifier (SSID), an encryption method, a cryptographic key, an authentication method, an AKM, a BSSID, a MAC Address, and the like. “AKM” is an acronym for “Authentication and Key Management”. “AKM” indicates an authentication protocol, a key exchange algorithm, and the like used for wireless communication. For example, if the AKM is “SAE”, the communication parameters can include a password for connecting to an AP or a GO supporting Wi-Fi Protected Access (WPA) 3. If the AKM is “psk”, the communication parameters can include a Pre Shared Key (PSK)/passphrase for connecting to an AP or a GO supporting WPA2. If the AKM is “1X”, an ID, a password, a public key, and the like for connecting to an AP supporting WPA-Enterprise can be included. Note that passwords, PSKs, and passphrases are cryptographic keys used when implementing authentication and key exchange based on WPA, IEEE 802.11, and the like. The WPS processing in step S604 is a WFD R1 communication parameter sharing sequence. Alternatively, a channel changed from the channel used in steps S601 to S603 may be used for communication in the processing from step S604 onward.

In step S605, when the MFP 100 itself is determined to operate as the GO, the MFP 100 starts sending a beacon frame. The beacon frame can include communication parameters for communicating with the MFP 100. The beacon frame can also include an information element (IE), Attributes, or the like defined in the WFD standard. Through this, communication apparatuses other than the mobile terminal device 104 can also detect the presence of the MFP 100 and make a wireless communication connection with the MFP 100 directly. For example, other communication apparatuses can detect the presence of the MFP 100 by receiving the Beacon frame including information defined in the WFD standard.

In step S606, the mobile terminal device 104 sends a Probe Request frame to execute a connection procedure with the MFP 100. In step S607, upon receiving the Probe Request frame, the MFP 100 sends a Probe Response frame.

In step S608, the mobile terminal device 104 sends an Authentication frame. In step S609, upon receiving the Authentication frame, the MFP 100 sends an Authentication frame.

In step S610, upon receiving the Authentication frame, the mobile terminal device 104 sends an Association Request frame. In step S611, upon receiving the Association Request frame, the MFP 100 sends an Association Response frame.

In step S612, the mobile terminal device 104 and the MFP 100 execute a 4-Way Handshake.

In the method for the first standard, the connection between the mobile terminal device 104 and the MFP 100 is established by executing a connection procedure such as that described above. Although not indicated in the foregoing sequence, the mobile terminal device 104 and the MFP 100 may send or receive Provision Discovery Request/Provision Discovery Response frames. The processing performed by the mobile terminal device 104 and the MFP 100 illustrated above may also be configured to be performed in an inverse manner.

### Second Connection Processing by Method Using Second Standard

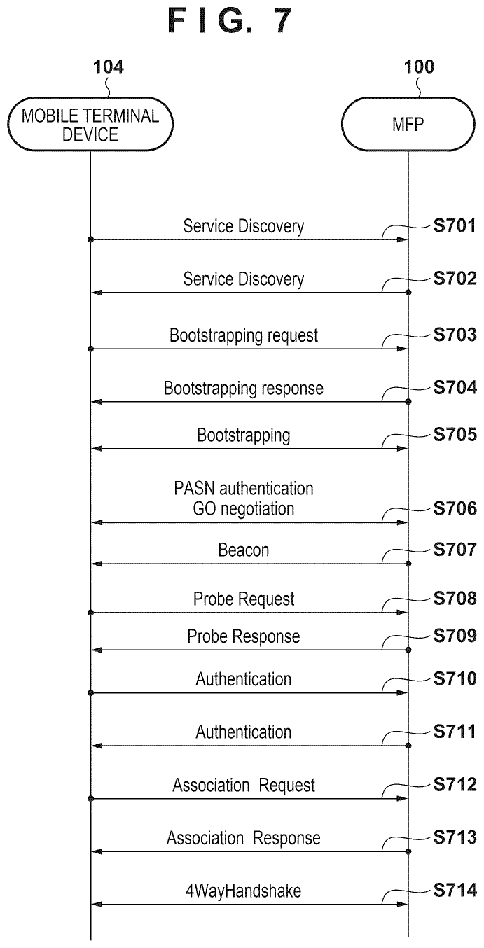

FIG. 7 is a sequence chart illustrating processing by which the mobile terminal device 104 and the MFP 100 connect in accordance with the WFD standard. A processing sequence for WFD R2 is illustrated here. Processing executed by each device in this sequence is implemented by the CPU of each device reading out various programs stored in a memory provided in that device, such as a ROM or the like, into a RAM and executing those programs.

For example, the processing of the sequence is started in the mobile terminal device 104 and the MFP 100 in response to receiving an instruction to start WFD from the user. In the WFD R2 search sequence, second search processing is performed. An example of a search procedure using the second search processing will be described. In this search procedure, the mobile terminal device 104 and the MFP 100 each executes processing based on whether the device itself is a communication apparatus providing a service or a communication apparatus requesting a service, and detect other communication apparatuses. The communication apparatus providing the service can be called a Publisher, a Listener, an Advertiser, or the like. The communication apparatus requesting the service can be called a Subscriber, a Searcher, a Seeker, or the like. For example, the communication apparatus requesting the service can send frames to detect other communication apparatuses. The communication apparatus providing the service can receive and respond to frames sent by other communication apparatuses. The role assigned to the communication apparatus can be determined by the upper layer (the service layer or the like). FIG. 7 illustrates an example in which the mobile terminal device 104 operates as the communication apparatus requesting the service and the MFP 100 operates as the communication apparatus providing the service. For example, the mobile terminal device 104 performs detection operations intermittently and sends frames for detecting other communication apparatuses. The Wi-Fi Aware standard system formulated by the Wi-Fi Alliance, for example, may be used in the second search processing. In other words, frames specified in the Wi-Fi Aware standard may be used as the frames communicated in the second search processing. Additionally, the second search processing is not limited to the Wi-Fi Aware standard, and other service search protocols and methods may be used.

In step S701, the mobile terminal device 104 sends a Service Discovery frame to search for a WFD communication apparatus. It is assumed here that Service Discovery is sent on channel 6 in the 2.4 GHz band. The partner device to be searched for is searched for by sending the Service Discovery frame. The Service Discovery frame sent by the mobile terminal device 104 in step S701 can also be said to be a request for wireless communication between the MFP 100 and the mobile terminal device 104 through WFD R2. It is assumed here that the communication apparatus performing the search is the mobile terminal device 104, and the partner device being searched for is the MFP 100. The Service Discovery frame has a WFD attribute, which specifies that the target of the search is a WFD communication apparatus. The Service Discovery frame also includes information indicating a device ID key identifying the mobile terminal device 104 and a validity period of the device ID key.

In step S702, upon receiving the Service Discovery frame, the MFP 100 sends a Service Discovery frame. The Service Discovery frame sent here is called an “SDF Follow up”. The mobile terminal device 104 detects the MFP 100 that is the WFD communication partner by receiving the Service Discovery frame. The second search processing described above is a WFD R2 search sequence. Because the first search processing in WFD R1 and the second search processing in WFD R2 use different methods, the WFD R2 method cannot be used to search for a communication apparatus which only supports WFD R1. Likewise, the WFD R1 method cannot be used to search for a communication apparatus which only supports WFD R2.

In step S703, the mobile terminal device 104 sends a request using a Bootstrapping Request frame. Here, the request is a request for a sharing method for the purpose of sharing communication parameters. The mobile terminal device 104 can use this frame to notify the MFP 100 of a sharing method that the mobile terminal device 104 itself can execute from among communication parameter sharing methods which use a button (an authentication-based method), a pin code, a passphrase, a QR code, a Near Field Communication (NFC) tag, or the like, for example. The present embodiment will describe a QR code as an example of a two-dimensional code image. For example, if the mobile terminal device 104 is capable of executing a sharing method that uses a QR code, the mobile terminal device 104 can indicate at least one of whether the mobile terminal device 104 itself is capable of displaying a QR code or capable of reading a QR code. If the mobile terminal device 104 is capable of executing a sharing method that uses a passphrase, the mobile terminal device 104 can also indicate whether a character string, a numerical value, or both can be used. If the mobile terminal device 104 is capable of executing a sharing method that uses a passphrase, the mobile terminal device 104 can indicate whether the passphrase can be displayed, entered, or both. The mobile terminal device 104 can also indicate whether a trigger for sharing communication parameters by pressing a button can be used. The information that can be communicated by the mobile terminal device 104 is not limited thereto.

In step S704, the MFP 100 responds to the request using a Bootstrapping Request frame. The MFP 100 sends the response to the mobile terminal device 104 using a Bootstrapping Response frame. In one example, the MFP 100 can select a sharing method that can be executed by the MFP 100 itself from among the sharing methods included in the request from the mobile terminal device 104, and provide a response that includes information capable of identifying the sharing method. In addition, if there is no method that can be executed by the device itself from among the sharing methods included in the request, a response that includes information indicating this fact can be provided.

In step S705, Bootstrapping processing is performed using the sharing method for sharing the communication parameters determined between the communication apparatuses, and the communication parameters are shared. For example, the communication parameters are shared by the MFP 100 displaying a QR code and the mobile terminal device 104 reading the QR code. The Bootstrapping processing in step S705 is WFD R2 communication parameter sharing processing. The WFD R2 communication parameter sharing processing is performed before the GO Negotiation processing. The communication parameters shared here include at least one (one or more) parameters used for wireless communication, from among an encryption method, a cryptographic key, an authentication method, AKM, and a BSSID (MAC address). A passphrase is also included when the parameters are shared by QR code.

In step S706, mutual authentication can be executed through PASN authentication. “PASN” is an acronym for “Preassociation Security Negotiation”. The communication parameters for using PASN can include a public key or the like of each communication apparatus. The communication parameters for using PASN can be shared using a method not specified in the WFD standard, such as Bluetooth or Bluetooth Low Energy. Alternatively, as another sharing method, a temporary network including an AP may be configured and the communication parameters may be obtained by connecting the communication apparatus to that network. In PASN, the mobile terminal device 104 and the MFP 100 can perform GO Negotiation processing. The channel to be used for direct wireless communication may be determined in the GO Negotiation. The roles of the P2P group owner (GO) and the P2P client are determined in the GO Negotiation processing. The MFP 100 may be started so as to be fixed as the parent station for WFD mode (Autonomous Group Owner). In this case, GO Negotiation processing for determining the role is unnecessary. The MFP 100 may ensure it itself always operates as the MFP 100, despite the GO Negotiation processing being executed, by setting the intent value for itself to a maximum of 15. Furthermore, in this case, the MFP 100 also determines the frequency band and the frequency channel to be used in direct wireless communication as the parent station. Accordingly, the MFP 100 can select which frequency band to use from 2.4 GHz, 5 GHz, or 6 GHz, as well as which frequency channel to use in that frequency band. In WFD R1, the frequency bands that can be used for direct wireless communication are 2.4 GHz and 5 GHz, but in WFD R2, the frequency bands that can be used for direct wireless communication are assumed to be 2.4 GHz, 5 GHz, and 6 GHz. Furthermore, unlike WFD R1, the roles are determined after sharing the communication parameters in WFD R2. A channel changed from the channel used in steps S701 to S706 may be used for communication in the processing from step S707 onward.

In step S707, when the MFP 100 itself is determined to operate as the GO, the MFP 100 starts sending a beacon frame. The beacon frame can include communication parameters for communicating with the MFP 100. The beacon frame can also include an information element (IE), Attributes, or the like defined in the WFD standard. Through this, communication apparatuses other than the mobile terminal device 104 can also detect the presence of the MFP 100 and connect to the MFP 100. For example, other communication apparatuses can detect the presence of the MFP 100 by receiving the Beacon frame including information defined in the WFD standard.

In step S708, the mobile terminal device 104 sends a Probe Request frame to execute a connection procedure with the MFP 100. In step S709, upon receiving the Probe Request frame, the MFP 100 sends a Probe Response frame.

In step S710, the mobile terminal device 104 sends an Authentication frame. In step S711, upon receiving the Authentication frame, the MFP 100 sends an Authentication frame.

In step S712, upon receiving the Authentication frame, the mobile terminal device 104 sends an Association Request frame. In step S713, upon receiving the Association Request frame, the MFP 100 sends an Association Response frame.

In step S714, the mobile terminal device 104 and the MFP 100 execute a 4-Way Handshake.

In the method for the second standard, the connection between the mobile terminal device 104 and the MFP 100 is established by executing a connection procedure such as that as described above. The processing performed by the mobile terminal device 104 and the MFP 100 illustrated above may be configured to be performed in an inverse manner. Whether WFD R1 or WFD R2 is supported can also be indicated by P2P IE.

In this manner, the WFD standard includes WFD R1 and WFD R2. Each device supporting the function publicized as Wi-Fi Direct, such as the mobile terminal device 104 and the MFP 100, can then connect directly, without going through an external AP, by performing either the first connection processing or the second connection processing.

Incidentally, the security level of WFD R1 corresponds to the WPA2 security mode. However, the security level of WFD R2 corresponds to the WPA, WPA2, and WPA3 security modes. WPA3 is a security mode with a higher security level than WPA2. In other words, WFD R2 supports a security mode with a higher security level than WFD R1.

In this manner, WFD R1 and WFD R2 are not compatible with some of the corresponding security modes. However, during the transition period accompanying the development of WFD R2, situations may arise where devices compliant with WFD R1 and devices compliant with WFD R2 coexist. For example, consider a case where WPA3 is used as the security mode when establishing a direct connection through the second connection processing between a device supporting only WFD R1 and a device supporting WFD R2. In such a case, as described above, WFD R1 does not support WPA3, and a direct connection between the devices therefore cannot be established.

Accordingly, in the present embodiment, the MFP 100 is capable of executing processing corresponding to both the WFD R1 and WFD R2 standards, as described above with reference to FIGS. 6 and 7. As a result, the MFP 100 can establish a direct connection even when the apparatus to be connected to only supports WFD R1. The MFP 100 can also establish a direct connection even when the apparatus to be connected to supports WFD R2.

Here, consider a case where a communication apparatus that supports both WFD R1 and WFD R2 standards, such as the MFP 100, makes a direct connection with an external device such as the mobile terminal device 104. In such a case, the communication apparatus may, for example, allow the user to set a direct connection with the external device through either the first connection processing or the second connection processing through a user interface (UI) screen or the like. However, when the communication apparatus connects directly to an external device, some users may be confused as to which processing should be used to make the direct connection. It is therefore desirable to improve the convenience when the communication apparatus makes a direct connection with an external device.

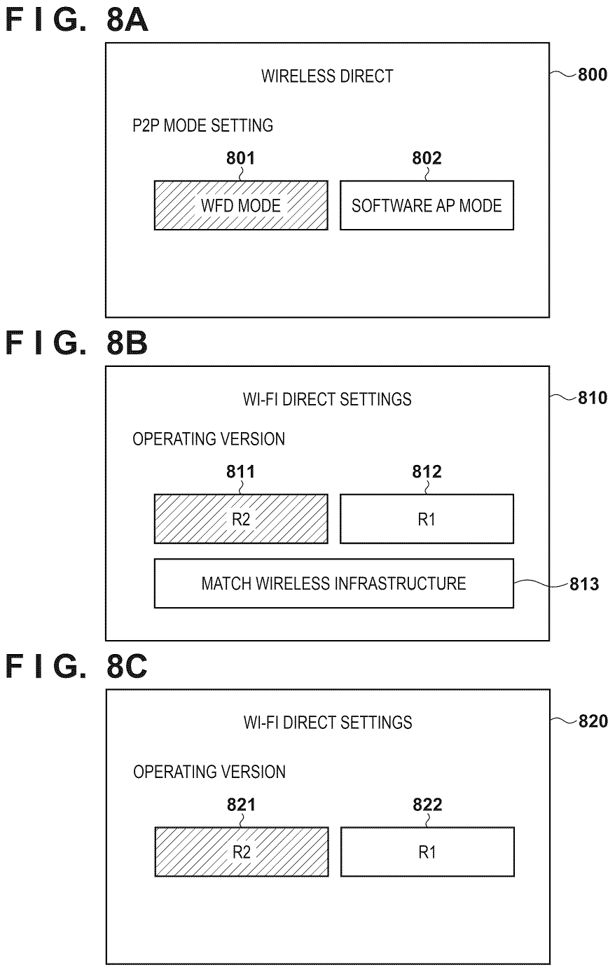

FIGS. 8A and 8B schematically illustrate examples of the display of settings screens for Wireless Direct in a display (a touchscreen) included in the console unit 220 of the MFP 100.

FIG. 8A illustrates an example of a menu screen 800 displayed when Wireless Direct is selected in FIG. 3C. The menu screen 800 is a screen for setting the operation mode of the wireless unit 226 when the MFP 100 makes a direct connection. The menu screen 800 displays a “WFD mode” button 801 and a “software AP mode” button 802. When, for example, the button 801 is pressed, the CPU 212 sets the wireless unit 226 to operate in WFD mode when the MFP 100 is to make a direct connection. Additionally, when, for example, the button 802 is pressed, the CPU 212 sets the wireless unit 226 to operate in software AP mode when the MFP 100 is to make a direct connection.

FIG. 8B illustrates an example of a settings screen 810 displayed when the button 801 is pressed (WFD mode has been selected) in the menu screen 800 illustrated in FIG. 8A. The settings screen 810 is a screen for setting the operating version of the wireless unit 226 when the MFP 100 is to make a direct connection through WFD. The settings screen 810 displays an “R2” button 811, an “R1” button 812, and a “match wireless infrastructure” button 813.

The button 811 is an acceptance button capable of accepting a user instruction to cause the wireless unit 226 to execute the second connection processing. In other words, the button 811 is a setting button for setting the wireless unit 226 to an operating version corresponding to WFD R2 when the MFP 100 is to make a direct connection through WFD.

The button 812 is an acceptance button capable of accepting a user instruction to cause the wireless unit 226 to execute the first connection processing. In other words, the button 812 is a setting button for setting the wireless unit 226 to an operating version corresponding to WFD R1 when the MFP 100 is to make a direct connection through WFD. The button 813 is an acceptance button capable of accepting a user instruction to cause the wireless unit 226 to perform either the first connection processing or the second connection processing based on information pertaining to the security mode used in the infrastructure connection. In other words, the button 813 is a setting button for setting the operating version of the wireless unit 226 according to the security mode used in the infrastructure connection when the MFP 100 is to make a direct connection through WFD.

When the button 811, the button 812, or the button 813 is pressed in the settings screen 810 illustrated in FIG. 8B, the CPU 212 stores a setting value corresponding to the button that has been pressed in the RAM 214 and the non-volatile memory 215. Then, as will be described later, when the MFP 100 is to make a direct connection through WFD, the CPU 212 determines the operating version of the wireless unit 226 based on the setting value stored in the RAM 214 and the non-volatile memory 215.

In this manner, in the present embodiment, providing the button 813 in the settings screen 810 makes it possible to improve the user convenience when the MFP 100 makes a direct connection with an external device such as the mobile terminal device 104. For example, even if the user is unsure whether the operating version of the wireless unit 226 should be set to R1 or R2, the burden on the user when making the settings can be reduced by operating the button 813.

Meanwhile, if the user knows whether the operating version of the wireless unit 226 should be set to R1 or R2, providing the button 811 and the button 812 in the settings screen 810 makes it possible to accept the corresponding settings individually.

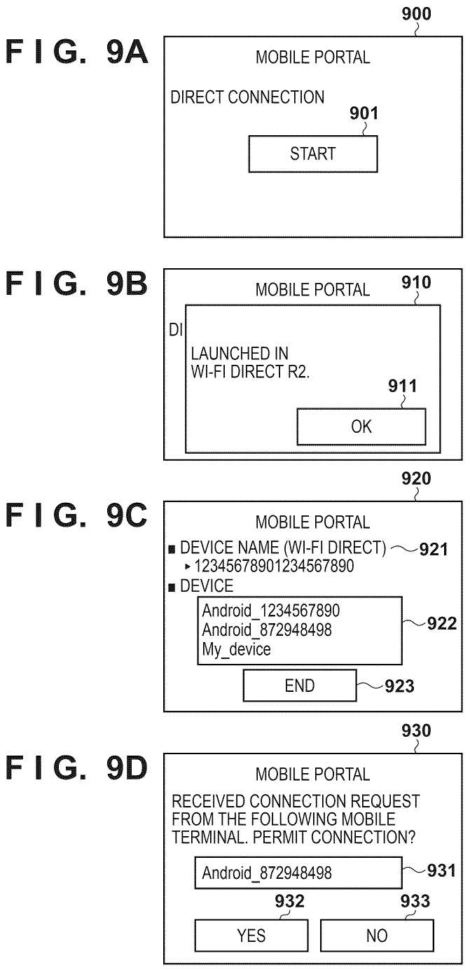

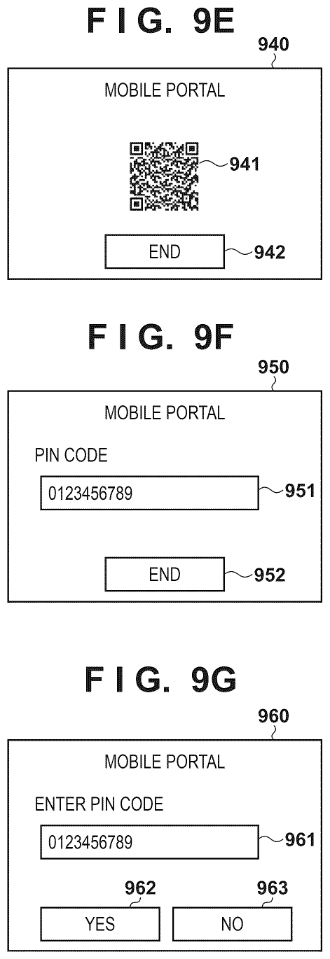

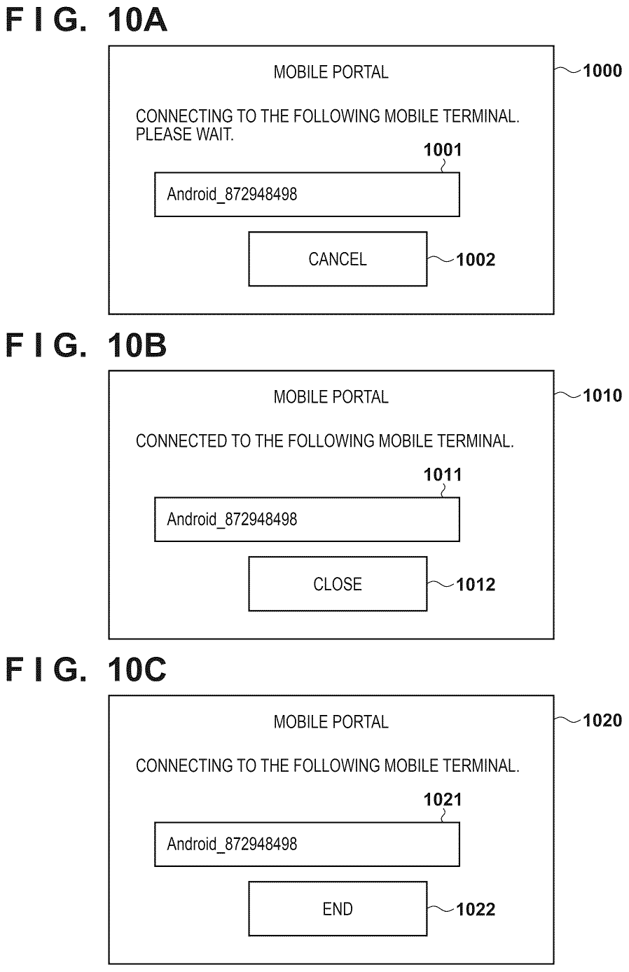

FIGS. 9A to 10C schematically illustrate examples of displays in a mobile portal screen (an operation screen used during direct connections) in a display (a touchscreen) included in the console unit 220 of the MFP 100.

FIG. 9A illustrates an example of a mobile portal screen 900 displayed when a mobile portal function (not shown) is selected in FIG. 3B. A “start” button 901 is displayed in the mobile portal screen 900. When the button 901 is pressed, the CPU 212 starts processing for making a direct connection in accordance with the mode specified in FIG. 8A. This processing will be described in detail later. In other words, the button 901 is an acceptance button capable of accepting a user instruction to cause the MFP 100 to start a direct connection. When the wireless unit 226 is to operate in WFD mode, the CPU 212 executes connection processing compliant with the WFD standard in accordance with the button pressed in the settings screen 810 illustrated in FIG. 8B.

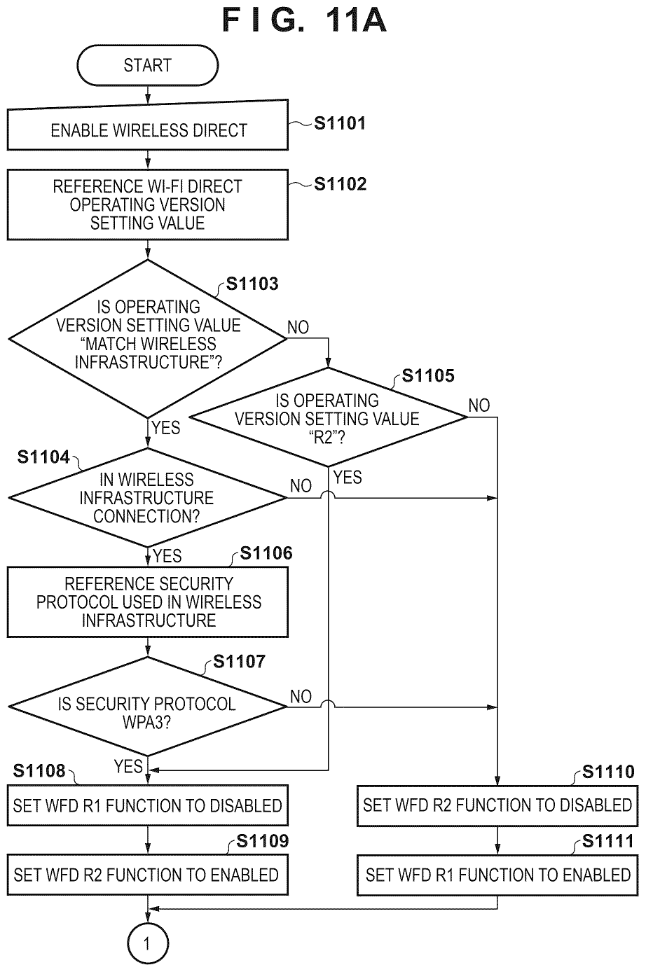

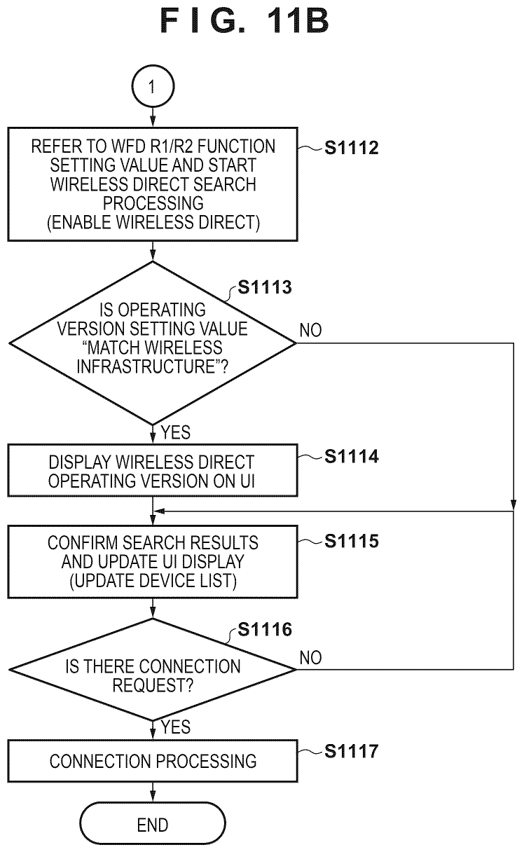

FIG. 9B is an example of the display of a notification screen 910 displayed when the button 813 is selected in the settings screen 810 illustrated in FIG. 8B. After the button 901 is pressed in the mobile portal screen 900, the notification screen 910 displays a message notifying the user of the WFD standard determined through the control by the CPU 212. For example, in the processing illustrated in FIGS. 11A and 11b (described later), if the information pertaining to the security mode used in the infrastructure connection is information indicating WPA3, the CPU 212 displays a message notifying the user that operations corresponding to WFD R2 (the second connection processing) have been started. Additionally, for example, in the processing illustrated in FIGS. 11A and 11B (described later), if the information pertaining to the security mode used in the infrastructure connection is information different from WPA3, the CPU 212 displays a message notifying the user that operations corresponding to WFD R1 (the first connection processing) have been started. The notification using such a message makes it possible for the user to recognize the operating version when the MFP 100 makes a direct connection with the external device. Note that the notification screen 910 is turned off (hidden) when an “OK” button 911 is pressed, or when a set length of time has passed.

FIG. 9C is an example of the display of a screen 920 displayed when the connection processing in the WFD standard has been started. The screen 920 includes a device name 921, a device list 922, an “end” button 923, and the like. The device name 921 displays identification information expressing the MFP 100 in P2P communication. The device list 922 displays a list of external devices detected by either the first search processing or the second search processing. The device list 922 can accept a user selection of the external device to be connected from the list of external devices. In other words, the screen 920 is a screen for the user to select the external device to be connected to through a direct connection. For example, upon accepting the user selection of the external device to be connected to, the CPU 212 sends a connection request to the selected external device through the device list 922. Note that if the button 923 has been pressed, the CPU 212 ends the connection processing in the WFD standard.

FIG. 9D is an example of the display of a parameter sharing screen 930 displayed when sharing parameters using a button-based method in the second connection processing performed through WFD R2 in FIG. 7 between the MFP 100 and the mobile terminal device 104. Text describing the operation to the user is displayed in the parameter sharing screen 930. The text describing the operation is a message indicating that a connection using WFD R2 in FIG. 7 has been requested, and asking whether to approve the connection. In addition, identification information of the device that requested the parameters to be shared, a “Yes” button 932, and a “No” button 933 are displayed in the parameter sharing screen 930. The user selecting the “Yes” button 932 corresponds to an operation indicating that parameter sharing is allowed (approved) being performed, and the parameters necessary to establish the connection through WFD R2 in FIG. 7 are shared between the MFP 100 and the mobile terminal device 104. On the other hand, if the user selects the “No” button 933, the WFD R2 connection processing between the MFP 100 and the mobile terminal device 104, indicated in FIG. 7, is aborted. In the button-based method, an operation for approving the parameter sharing is presented (displaying the “Yes” button 932, presenting a physical key to accept the approval operation, or the like) based on the parameter sharing request (Bootstrapping Request) having been received. Then, when an approval operation is performed (a display button is operated, a physical key operation corresponding to the approval operation is performed, or the like), the parameters are sent by wireless communication to the device that made the parameter sharing request. In this manner, with the button-based method, the parameters can be shared through an easy user operation.

FIGS. 9E to 9G illustrate examples of parameter sharing screens displayed in the console unit 220 in the second connection processing through WFD R2 in FIG. 7, performed between the MFP 100 and the mobile terminal device 104. When an external device to be connected is selected in the screen 920 in FIG. 9C, the CPU 212 determines the communication parameter sharing method between the MFP 100 and the mobile terminal device 104, and displays the parameter sharing screen. In addition, when the MFP 100 receives the Bootstrapping Request from the mobile terminal device 104, the CPU 212 determines the communication parameter sharing method between the MFP 100 and the mobile terminal device 104, and displays the parameter sharing screen. Note that the CPU 212 determines which of the parameter sharing screens illustrated in FIGS. 9E to 9G to display based on a setting value for the parameter sharing method, accepted through a user selection in advance.

FIG. 9E is an example of the display of a parameter sharing screen 940 displayed when sharing parameters using a QR code-based method in the second connection processing performed through WFD R2 in FIG. 7 between the MFP 100 and the mobile terminal device 104. A “QR code” item 941 and an “end” button 942 are displayed in the parameter sharing screen 940. The name of the mobile terminal device 104 executing the connection request through WFD may be displayed in the parameter sharing screen 940. A code image containing parameter information, such as a BSSID, a passphrase, or the like, for establishing a connection through WFD R2 in FIG. 7, is displayed in the “QR code” item 902.

FIGS. 9F and 9G are examples of the display of parameter sharing screens displayed when sharing parameters using a PIN code-based method in the second connection processing performed through WFD R2 in FIG. 7 between the MFP 100 and the mobile terminal device 104.

A parameter sharing screen 950 illustrated in FIG. 9F displays a PIN code display part 951, an “end” button 952, and the like. The PIN code display part 951 displays a PIN code to be entered in the mobile terminal device 104. In other words, FIG. 9F illustrates a screen displayed when the MFP 100 is requested to share parameters from the mobile terminal device 104. In addition, a parameter sharing screen 960 illustrated in FIG. 9G displays a PIN code entry part 961, a “Yes” button 962, a “No” button 963, and the like. The PIN code entry part 961 is an item that can accept the entry of a PIN code to be sent to the mobile terminal device 104. The button 962 is a button capable of accepting a user instruction to send the PIN code accepted by the PIN code entry part 961 to the mobile terminal device 104. Note that the button 952 and the button 963 are buttons capable of accepting a user instruction to end the second connection processing.

FIG. 10A is an example of the display of a screen 1000 displayed when authentication processing for the connection processing in the WFD standard has been started. Specifically, when the MFP 100 starts the first connection processing with the mobile terminal device 104, the screen 1000 is displayed at the next timing. For example, the screen 1000 is displayed when a user selection of the mobile terminal device 104 to be connected to has been accepted in the device list 922 of the screen 920 illustrated in FIG. 9C. For example, the screen 1000 is displayed when the button 932 is pressed in the screen 930 illustrated in FIG. 9D. When the MFP 100 starts the second connection processing with the mobile terminal device 104, the screen 1000 is displayed at the next timing. For example, the screen 1000 is displayed when parameter sharing is complete. The screen 1000 displays a device display part 1001. The device display part 1001 displays identification information indicating the mobile terminal device 104 with which the MFP 100 is executing the connection processing according to the WFD standard. Note that the connection processing in the WFD standard is suspended when a button 1002 is pressed.

FIG. 10B is an example of the display of a screen 1010 displayed when the connection processing in the WFD standard is complete. The screen 1010 displays a device display part 1011. The device display part 1011 displays identification information indicating the external device for which the connection processing in the WFD standard has succeeded (the mobile terminal device 104 with which the MFP 100 has established a direct connection). Note that the CPU 212 switches the display to a screen 1020, illustrated in FIG. 10C, when a “close” button 1012 is pressed, or when a set length of time has passed.

FIG. 10C is an example of the display of the screen 1020 displayed when the MFP 100 is in a direct connection with an external device. A device display part 1021 is displayed in the screen 1020. The device display part 1021 displays identification information indicating the external device to which the MFP 100 is directly connected. When an “end” button 1022 is pressed, the CPU 212 cuts the direct connection between the MFP 100 and the mobile terminal device 104.

### Connection Processing Executed by MFP 100

FIGS. 11A and 11B are flowcharts illustrating an example of processing performed by the MFP 100 for establishing a direct connection. The processing illustrated in FIGS. 11A and 11B are implemented, for example, by the CPU 212 reading out various programs stored in a storage region such as the ROM 213 of the MFP 100 into the RAM 214 and executing those programs. The processing illustrated in FIGS. 11A and 11B are started, for example, when the CPU 212 detects that the button 901 has been pressed in the screen 900 illustrated in FIG. 9A.

In step S1101, the CPU 212 starts Wireless Direct operations in the MFP 100. Specifically, for example, the CPU 212 starts operations in WFD mode as the Wireless Direct operations of the MFP 100. In other words, the CPU 212 causes the wireless unit 226 to operate in WFD mode. Note that the CPU 212 may start operations in both WFD mode and software AP mode as the Wireless Direct operations of the MFP 100.

In step S1102, the CPU 212 refers to the setting value for the operating version used when the wireless unit 226 is operating in WFD mode. As described above, when the button 811, the button 812, or the button 813 is pressed in the settings screen 810 illustrated in FIG. 8B, the CPU 212 stores a setting value corresponding to the button that has been pressed in the RAM 214 and the non-volatile memory 215. In step S1102, the CPU 212 obtains, from the RAM 214 and the non-volatile memory 215, the setting value for the operating version used when the wireless unit 226 is operating in WFD mode.

In step S1103, the CPU 212 determines whether the setting value for the operating version in WFD mode, referred to in step S1101, is “match wireless infrastructure”. If the CPU 212 determines that the setting is “match wireless infrastructure”, the sequence moves to step S1104. However, if the CPU 212 determines that the setting is not “match wireless infrastructure”, the sequence moves to step S1105.

In step S1104, the CPU 212 determines whether the MFP 100 is currently in an infrastructure connection. In other words, the CPU 212 determines whether the MFP 100 is connected to the mobile terminal device 104 via the external AP 101. If the CPU 212 determines that the MFP 100 is currently in an infrastructure connection, the sequence moves to step S1106. However, if the CPU 212 determines that the MFP 100 is not currently in an infrastructure connection, the sequence moves to step S1110. Note that this determination is not limited to this method, and may be made by determining whether the MFP 100 is connected to the external AP 101.

In step S1105, the CPU 212 determines whether the setting value for the operating version in WFD referred to (obtained) in step S1102 is “R2”. If the CPU 212 determines that the setting is “R2”, the sequence moves to step S1108. However, if the CPU 212 determines that the setting is not “R2”, the sequence moves to step S1110. In other words, in step S1105, the CPU 212 determines whether the button 811 has been pressed in the screen 810 illustrated in FIG. 8B.

In step S1106, the CPU 212 refers to (obtains) information indicating the security mode used in the infrastructure connection, stored in the RAM 214 and the non-volatile memory 215.

Specifically, for example, if the MFP 100 is in an infrastructure connection with an external device such as the mobile terminal device 104 via an external AP such as the AP 101, the MFP 100 is connected to an external AP. If the MFP 100 is connected to an external AP, the CPU 212 stores information pertaining to the external AP in, for example, the RAM 214 and the non-volatile memory 215. The information pertaining to the external AP is information for connecting to the external AP, and includes, for example, an SSID, a password, or the like of the external AP. Additionally, the information pertaining to the external AP includes information pertaining to the security mode supported by the external AP. In step S1106, the CPU 212 obtains the information pertaining to the security mode supported by the external AP from the RAM 214 and the non-volatile memory 215, for example. Specifically, the information indicating the security mode used in the infrastructure connection is, for example, the information pertaining to the security mode supported by the external AP. The “information pertaining to the security mode” is information indicating a security protocol. Specifically, the information pertaining to the security mode is, for example, information indicating an authentication method supported by the external AP and information indicating an encryption method supported by the external AP.

In step S1107, the CPU 212 determines whether the security mode used in the infrastructure connection is “WPA3 mode”. The CPU 212 makes this determination based on the information pertaining to the security mode used in the infrastructure connection obtained in step S1106. If the CPU 212 determines that the mode is “WPA3 mode”, the sequence moves to step S1108. However, if the CPU 212 determines that the mode is not “WPA3 mode”, the sequence moves to step S1110.

In step S1108, the CPU 212 disables the setting value for the WFD R1 function, and stores the disabled setting value in the RAM 214. The setting of the WFD R1 function being disabled indicates that the WFD R1 processing sequence illustrated in FIG. 6 cannot be executed. In other words, in step S1108, the CPU 212 sets the MFP 100 to a state in which operations corresponding to WFD R1 (the first connection processing) cannot be executed by the wireless unit 226.

In step S1109, the CPU 212 enables the setting value for the WFD R2 function, and stores the enabled setting value in the RAM 214. The setting value of the WFD R2 function being enabled indicates that the WFD R2 processing sequence illustrated in FIG. 7 can be executed. In other words, in step S1109, the CPU 212 sets the MFP 100 to a state in which operations corresponding to WFD R2 (the second connection processing) can be executed by the wireless unit 226.

In this manner, in the present embodiment, if the information pertaining to the security mode used in the infrastructure connection indicates the WPA3 mode (YES in S1107), it is likely that the external device with which the direct connection is made also supports the WPA3 mode. Accordingly, if the information pertaining to the security mode used in the infrastructure connection indicates the WPA3 mode, the CPU 212 enables the WFD R2 function.

In step S1110, the CPU 212 disables the setting value for the WFD R2 function, and stores the disabled setting value in the RAM 214. The setting of the WFD R2 function being disabled indicates that the WFD R2 processing sequence illustrated in FIG. 7 cannot be executed. In other words, in step S1110, the CPU 212 sets the MFP 100 to a state in which operations corresponding to WFD R2 (the second connection processing) cannot be executed by the wireless unit 226.

In step S1111, the CPU 212 enables the setting value for the WFD R1 function, and stores the enabled setting value in the RAM 214. The setting of the WFD R1 function being enabled indicates that the WFD R1 processing sequence illustrated in FIG. 6 can be executed. In other words, in step S1111, the CPU 212 sets the MFP 100 to a state in which operations corresponding to WFD R1 (the first connection processing) can be executed by the wireless unit 226.

In the present embodiment, if the MFP 100 is not in an infrastructure connection (NO in step S1104), the CPU 212 enables the setting of the WFD R1 function and controls the wireless unit 226 to make a direct connection through the first connection processing. In other words, if the information pertaining to the security mode used in the infrastructure connection cannot be obtained, the CPU 212 enables the setting of the WFD R1 function. As described above, WFD R2 supports a security mode having a higher security level than WFD R1 (WPA3). In addition, depending on the device to which the direct connection is made, WPA3 may not be supported. Accordingly, if, for example, the WFD R2 function is enabled in a state where the CPU 212 cannot obtain the security mode used in the infrastructure connection, the MFP 100 may be unable to establish a direct connection with the external device. Accordingly, if the security mode used in the infrastructure connection cannot be obtained, the CPU 212 enables the WFD R1 function.

In addition, if the security mode used by the MFP 100 in the infrastructure connection is not WPA3 (NO in step S1107), it is possible that the mobile terminal device 104 with which the infrastructure connection is currently established does not support WFD R2. Accordingly, in the present embodiment, if the security mode used by the MFP 100 in the infrastructure connection is not WPA3 (NO in step S1107), the CPU 212 enables the setting value for the WFD R1 function.

In step S1112, the CPU 212 refers to the setting value for the WFD R1 function and the setting value for the WFD R2 function stored in the RAM 214, and starts either the first connection processing or the second connection processing. Specifically, if the processing of steps S1108 and S1109 has been executed, the WFD R2 function is enabled, and thus the CPU 212 executes the second search processing. Through this, the mobile terminal device 104 supporting WFD R2 is discovered. In other words, the mobile terminal device 104 capable of establishing a direct connection using the security mode compliant with WFD R2 is discovered. On the other hand, if the processing of steps S1110 and S1111 has been executed, the WFD R1 function is enabled, and thus the CPU 212 executes the first search processing. Through this, a mobile terminal device supporting WFD R1 is discovered. In other words, the mobile terminal device 104 capable of establishing a direct connection using the security mode compliant with WFD R1 is discovered. The mobile terminal device 104 discovered in this processing is displayed in the screen 920 illustrated in FIG. 9C.

In step S1113, the CPU 212 determines whether the setting value for the operating version used when the wireless unit 226 is operating in WFD mode, referred to (obtained) in step S1102, is “match wireless infrastructure”. If the CPU 212 determines that the setting is “match wireless infrastructure”, the sequence moves to step S1114. However, if the CPU 212 determines that the setting is not “match wireless infrastructure”, the sequence moves to step S1115.

In step S1114, the CPU 212 notifies the user which of the first connection processing or the second connection processing is to be performed by the wireless unit 226. Specifically, the CPU 212 displays the notification screen 910 illustrated in FIG. 9B in the console unit 220.

In step S1115, the CPU 212 displays, in the device list 922 in FIG. 9C, identification information indicating the mobile terminal device 104 discovered through the search processing executed in step S1112. This processing is executed again if no connection request is made from the mobile terminal device 104 discovered through the search processing executed in step S1112 (NO in step S1116). In addition, if another external device is discovered, that device is added to the device list 922, and if the mobile terminal device 104 displayed in the device list 922 can no longer be discovered, that device is removed from the device list 922.

In step S1116, the CPU 212 determines whether a connection request has been made. If the CPU 212 determines that a connection request has been made, the sequence moves to step S1117. However, if the CPU 212 determines that a connection request has not been made, the sequence moves to step S1115. Specifically, the CPU 212 determines that a connection request has been made if, for example, a user selection of an external device to be connected to has been accepted in the device list 922 displayed in the screen 920 (see FIG. 9C). However, the CPU 212 determines that no connection request has been made if, for example, a user selection has not been accepted in the device list 922. In other words, in step S1116, the CPU 212 determines whether a user instruction for sending a connection request has been received.

In step S1117, the CPU 212 performs connection processing with the mobile terminal device 104 for which a connection request was determined to have been made in step S1116, and establishes a direct connection between the MFP 100 and the mobile terminal device 104. Note that the direct connection established in the connection processing of step S1117 is a connection based on the settings executed in step S1109 or step S1111.

In other words, if the connection processing in step S1107 is executed through step S1109, the direct connection established between the mobile terminal device 104 and the MFP 100 is executed based on the WFD R2 function. Specifically, the CPU 212 causes the wireless unit 226 to execute the second connection processing illustrated in FIG. 7, but does not cause the wireless unit 226 to execute the first connection processing illustrated in FIG. 6. For example, the CPU 212 issues a response to the Wireless Direct search processing executed by the mobile terminal device 104 based on the WFD R2 function, a response to the connection request sent by the mobile terminal device 104 based on the WFD R2 function, or the like. On the other hand, the CPU 212 does not issue a response to the Wireless Direct search processing executed by the mobile terminal device 104 based on the WFD R1 function, a response to the connection request sent by the mobile terminal device 104 based on the WFD R1 function, or the like.

Meanwhile, if the connection processing in step S1107 is executed through step S1111, the direct connection established between the mobile terminal device and the MFP 100 is executed based on the WFD R1 function. Specifically, the CPU 212 executes the first connection processing illustrated in FIG. 6, but does not execute the second connection processing illustrated in FIG. 7. For example, the CPU 212 issues a response to the Wireless Direct search processing executed by the mobile terminal device 104 based on the WFD R1 function, a response to the connection request sent by the mobile terminal device based on the WFD R1 function, or the like. On the other hand, the CPU 212 does not issue a response to the Wireless Direct search processing executed by the mobile terminal device 104 based on the WFD R2 function, a response to the connection request sent by the mobile terminal device 104 based on the WFD R2 function, or the like.

Specifically, in step S1117, the CPU 212 sends a connection request to the mobile terminal device 104 selected by the user in the device list 922. The CPU 212 may also switch the displayed details to the screen 1000 (see FIG. 10A) indicating that processing for connecting to the mobile terminal device 104 selected by the user in the screen 920 in FIG. 9C is being executed.

Note that upon receiving the connection request from the MFP 100, the mobile terminal device 104 displays a screen (not shown) indicating that the connection request has been received. The mobile terminal device 104 accepts a user operation for allowing the connection. The mobile terminal device 104 then sends a notification to the MFP 100 indicating that the connection is to be allowed. As a result, a direct connection is established between the mobile terminal device 104 selected by the user in the device list 922 and the MFP 100. At this time, the CPU 212 may switch the displayed content to the screen 1010 (see FIG. 10B) indicating that a connection through WFD has been established between the mobile terminal device 104 and the MFP 100.

Although the present embodiment describes the CPU 212 as determining whether to accept the user selection of the external device to be connected to using the device list 922 displayed in the screen 920 (see FIG. 9C) in step S1116, the configuration is not limited thereto. For example, the CPU 212 may determine whether a connection request has been received from the mobile terminal device 104.

In other words, if a connection request is determined to have been received from the mobile terminal device 104 in step S1116, the CPU 212 moves the sequence to step S1117, and a direct connection between the mobile terminal device 104 and the MFP 100 can also be established. Specifically, for example, the CPU 212 can issue a response to the Wireless Direct search processing executed by the mobile terminal device 104, a response to the connection request sent by the mobile terminal device 104, or the like while the screen 920 illustrated in FIG. 9C is being displayed. In other words, it is assumed that the CPU 212 will not issue a response to the Wireless Direct search processing executed by the mobile terminal device 104, a response to the connection request sent by the mobile terminal device 104, or the like while the screen 920 illustrated in FIG. 9C is not being displayed. However, the configuration is not limited thereto, and the above-described responses may be executed even while the screen 920 illustrated in FIG. 9C is not displayed.

When the mobile terminal device 104 receives a response to the Wireless Direct search processing from the MFP 100, the mobile terminal device 104 displays the MFP 100 as a result of the Wireless Direct search processing. Then, if the MFP 100 is selected by the user as the device to be connected to, the mobile terminal device 104 sends a connection request to the MFP 100. Then, when the connection request is received from the mobile terminal device 104, the CPU 212 switches the displayed content to the screen 940 (FIG. 9D) indicating that the connection request has been received from the mobile terminal device 104. The CPU 212 also accepts a user selection of whether to allow the connection with the mobile terminal device 104. The CPU 212 may switch the displayed content to the screen 1000 (FIG. 10A) indicating that processing for connecting to the selected mobile terminal device 104 is being executed. The CPU 212 then sends a notification to the mobile terminal device 104 indicating that the connection is to be allowed. As a result, a direct connection through WFD is established between the mobile terminal device 104 and the MFP 100 that received the connection request from the mobile terminal device 104. At this time, the CPU 212 may switch the displayed content to the screen 1010 (FIG. 10B) indicating that a direct connection through WFD has been established between the mobile terminal device 104 and the MFP 100.

As described thus far, according to the present embodiment, the CPU 212 performs the following processing when directly connecting the MFP 100. When the button 813 is pressed, the CPU 212 obtains information indicating the security mode used in the infrastructure connection (step S1106). Then, if the obtained information pertaining to the security mode is information indicating WPA3, the CPU 212 enables the setting of the WFD R2 function (step S1109). However, if the obtained information pertaining to the security mode is information indicating a security mode different from WPA3, the CPU 212 enables the setting of the WFD R1 function (step S1111). Then, the CPU 212 establishes a direct connection between the MFP 100 and the mobile terminal device 104 by executing the WFD standard connection processing based on the enabled settings (steps S1112 to S1117). In other words, the CPU 212 controls the wireless unit 226 to make a direct connection based on the information pertaining to the security mode obtained in step S1106. Such control makes it possible to lighten the burden when the user is unsure about the settings pertaining to direct connections when making a direct connection between the MFP 100 and the mobile terminal device 104.

### Second Embodiment

The following will describe areas that are different from the first embodiment. In the first embodiment, if the MFP 100 was not in an infrastructure connection (NO in step S1104), the CPU 212 enabled the setting of the WFD R1 function and controlled the wireless unit 226 to make a direct connection through the first connection processing.

Incidentally, even if the MFP 100 is not in an infrastructure connection, it is possible that an external AP is present around the MFP 100. If an external AP is present around the MFP 100, it is possible that a device such as the mobile terminal device 104 is connected to that external AP. In other words, it is possible that an external AP to which the MFP 100 is not currently connected, but which the user is using, is present around the MFP 100. Accordingly, in the present embodiment, if the MFP 100 is not in an infrastructure connection, the CPU 212 searches for an external AP that is present around the MFP 100. The CPU 212 then controls the wireless unit 226 to make a direct connection through either the first connection processing or the second connection processing based on the information pertaining to the security mode used by the external AP discovered through the search.

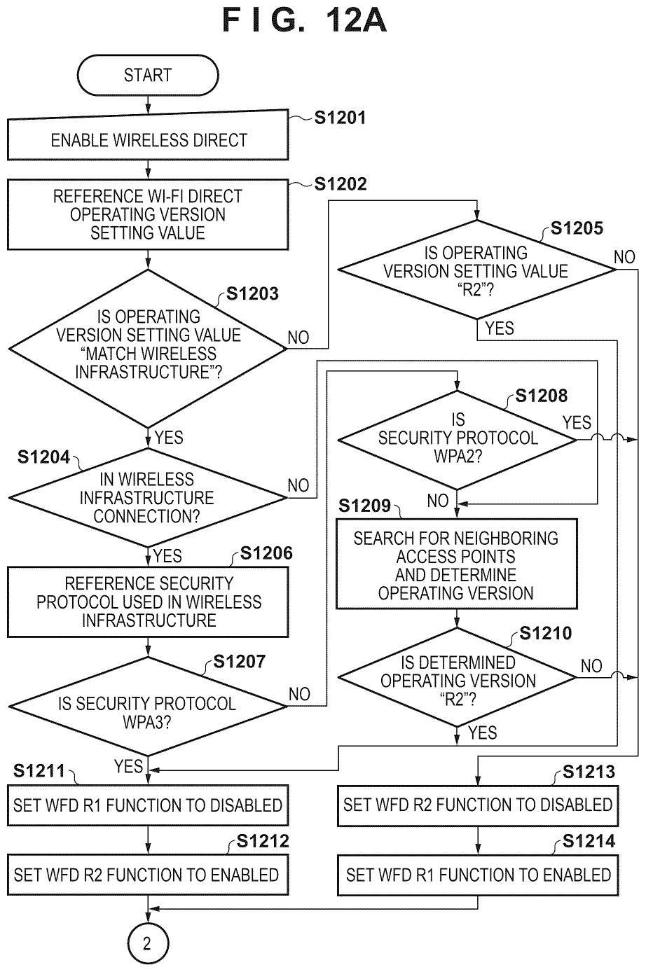

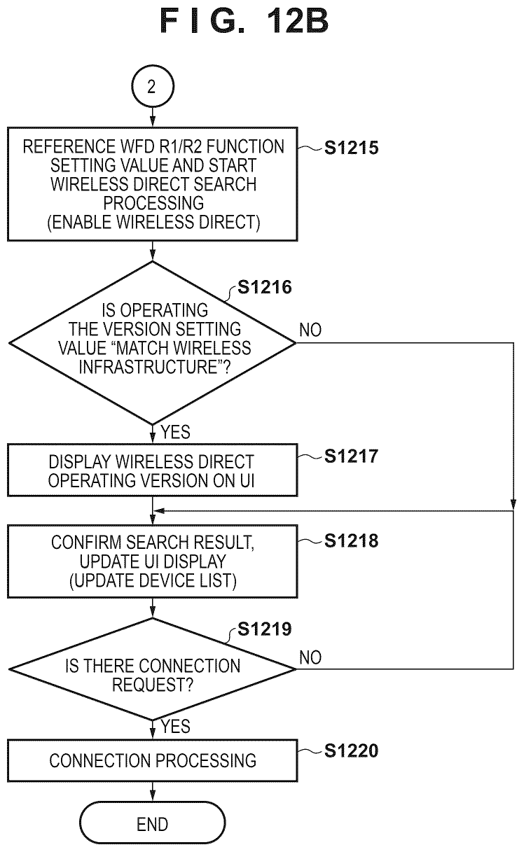

FIGS. 12A and 12B are flowcharts illustrating an example of processing performed by the MFP 100 for establishing a direct connection in the present embodiment. The processing illustrated in FIGS. 12A and 12B is implemented, for example, by the CPU 212 reading out various programs stored in a storage region such as the ROM 213 of the MFP 100 into the RAM 214 and executing those programs. The processing illustrated in FIGS. 12A and 12B is started, for example, when the CPU 212 detects that the button 901 has been pressed in the screen 900 illustrated in FIG. 9A.

The processing of steps S1201 to S1203 is the same as that of steps S1101 to S1103 in FIG. 11A, and will therefore not be described here.

In step S1204, the CPU 212 determines whether the MFP 100 is currently in an infrastructure connection. In other words, the CPU 212 determines whether the MFP 100 is connected to the mobile terminal device 104 via the external AP 101. If the CPU 212 determines that the MFP 100 is currently in an infrastructure connection, the sequence moves to step S1206. However, if the CPU 212 determines that the MFP 100 is not currently in an infrastructure connection, the sequence moves to step S1209.

The processing of steps S1205 and S1206 is the same as that of steps S1105 and S1106 in FIG. 11A, and will therefore not be described here.

In step S1207, the CPU 212 determines whether the security mode used in the infrastructure connection is “WPA3 mode”. The CPU 212 makes this determination based on the information pertaining to the security mode used in the infrastructure connection obtained in step S1206. If the CPU 212 determines that the mode is “WPA3 mode”, the sequence moves to step S1211. However, if the CPU 212 determines that the mode is not “WPA3 mode”, the sequence moves to step S1208.

In step S1208, the CPU 212 determines whether the security mode used in the infrastructure connection is “WPA2 mode”. The CPU 212 makes this determination based on the information pertaining to the security mode used in the infrastructure connection obtained in step S1206. If the CPU 212 determines that the mode is “WPA2 mode”, the sequence moves to step S1213. However, if the CPU 212 determines that the mode is not “WPA2 mode”, the sequence moves to step S1209.

In step S1209, the CPU 212 searches for an AP around the MFP 100. For example, the CPU 212 discovers an AP around the MFP 100 by receiving a beacon emitted by the AP around the MFP 100. The beacon emitted by the AP includes information pertaining to the security mode supported by the AP. The CPU 212 then determines the operating version of the wireless unit 226 based on the information pertaining to the security mode used by the AP discovered through the search. Specifically, the CPU 212 determines whether the security mode supported by the discovered AP is the WPA3 mode. If the CPU 212 determines that the mode is WPA3 mode, for example, the operating version of the wireless unit 226 is determined to be “R2”. However, if the CPU 212 determines that the security mode supported by the discovered AP is not the WPA3 mode, the operating version of the wireless unit 226 is determined to be “R1”. Note that in step S1209, if the CPU 212 is unable to discover an AP through the search, the operating version of the wireless unit 226 may be determined to be “R1”.

Note also that in step S1209, the CPU 212 may take information such as the radio wave strength, the SSID, and the like of the AP into account when determining the operating version of the wireless unit 226 based on the information pertaining to the security mode used by the AP discovered through the search. For example, if a plurality of APs are discovered through the search, the CPU 212 may determine the operating version of the wireless unit 226 based on the information pertaining to the security mode used by the AP having the highest radio wave strength among the plurality of APs discovered.

Additionally, in step S1209, if, for example, a plurality of APs are discovered through the search, the CPU 212 may identify an AP to which the MFP 100 has connected in the past based on the SSIDs of the discovered APs. The CPU 212 may then determine the operating version of the wireless unit 226 based on the information pertaining to the security mode used by the AP to which the MFP 100 has connected in the past.

In step S1210, the CPU 212 determines whether the operating version determined in step S1209 is “R2”. If the CPU 212 determines that the setting is “R2”, the sequence moves to step S1211. However, if the CPU 212 determines that the setting is not “R2”, the sequence moves to step S1213.

The processing of steps S1211 to S1220 is the same as that of steps S1108 to S1117 in FIGS. 11A and 11B, and will therefore not be described here.

As described thus far, according to the present embodiment, if the MFP 100 is not in an infrastructure connection (NO in step S1204), the CPU 212 moves the sequence to step S1209, and searches for an external AP that is present around the MFP 100. Then, if the information pertaining to the security mode used by the discovered external AP is information indicating the WPA3 mode, the CPU 212 enables the WFD R2 function. However, if the information pertaining to the security mode used by the discovered external AP is not information indicating the WPA3 mode, the CPU 212 enables the WFD R1 function. In other words, the CPU 212 then controls the wireless unit 226 to make a direct connection through either the first connection processing or the second connection processing based on the information pertaining to the security mode used by the external AP discovered through the search.

Such a configuration makes it possible to set the appropriate function based on the information pertaining to the security mode used by the AP around the MFP 100, even if the MFP 100 is not in an infrastructure connection.

Additionally, in the present embodiment, even if the MFP 100 is in an infrastructure connection, if the security mode used in the infrastructure connection is neither the WPA3 mode nor the WPA2 mode (NO in step S1208), the CPU 212 moves the sequence to step S1209. The security mode used in the infrastructure connection being neither the WPA3 mode nor the WPA2 mode indicates that the security mode supported by the AP 101 is the WPA mode. WPA is a security mode with a lower security level than WPA2 and WPA3. In this manner, even if the MFP 100 is in an infrastructure connection, the security level of the security mode used in the infrastructure connection may be lower than WPA2 and WPA3. In such a case, the CPU 212 can set a more appropriate function by enabling either the WFD R1 function or the WFD R2 function based on the security mode of the AP discovered by searching for the external AP.

### Third Embodiment

A third embodiment will be described next, focusing on differences from the first embodiment and the second embodiment. In the present embodiment, if the MFP 100 is not in an infrastructure connection, the CPU 212 obtains information pertaining to the security mode used by the MFP 100 in a past infrastructure connection. Then, based on the obtained information pertaining to the security mode used by the MFP 100 in the past infrastructure connection, the CPU 212 enables either the WFD R1 function or the WFD R2 function.

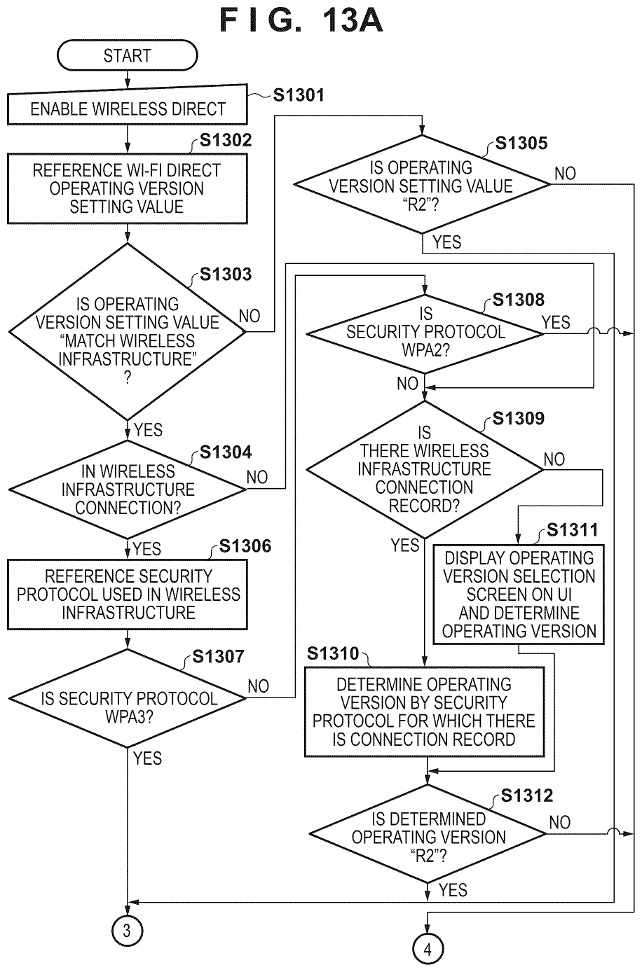

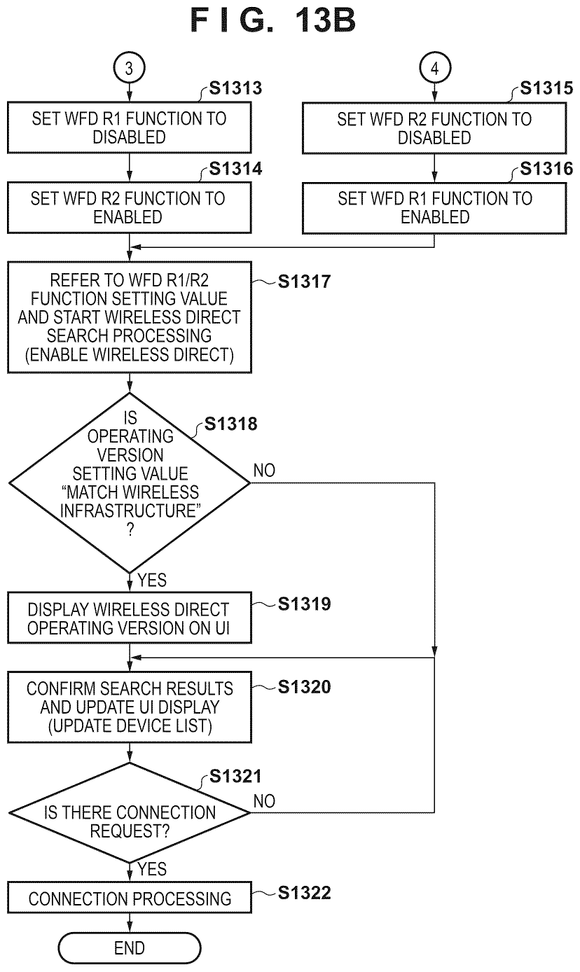

FIGS. 13A and 13B are flowcharts illustrating an example of processing performed by the MFP 100 for establishing a direct connection in the present embodiment. The processing illustrated in FIGS. 13A and 13B are implemented, for example, by the CPU 212 reading out various programs stored in a storage region such as the ROM 213 of the MFP 100 into the RAM 214 and executing those programs. The processing illustrated in FIGS. 13A and 13B are started, for example, when the CPU 212 detects that the button 901 has been pressed in the screen 900 illustrated in FIG. 9A.

The processing of steps S1301 to S1303 is the same as that of steps S1101 to S1103 in FIG. 11A, and will therefore not be described here.

In step S1304, the CPU 212 determines whether the MFP 100 is currently in an infrastructure connection. In other words, the CPU 212 determines whether the MFP 100 is connected to the mobile terminal device 104 via the external AP 101. If the CPU 212 determines that the MFP 100 is currently in an infrastructure connection, the sequence moves to step S1306. However, if the CPU 212 determines that the MFP 100 is not currently in an infrastructure connection, the sequence moves to step S1309.

The processing of steps S1305 and S1306 is the same as that of steps S1105 and S1106 in FIG. 11A, and will therefore not be described here.

In step S1307, the CPU 212 determines whether the security mode used in the infrastructure connection is “WPA3 mode”. The CPU 212 makes this determination based on the information pertaining to the security mode used in the infrastructure connection obtained in step S1306. If the CPU 212 determines that the mode is “WPA3 mode”, the sequence moves to step S1313. However, if the CPU 212 determines that the mode is not “WPA3 mode”, the sequence moves to step S1308.

In step S1308, the CPU 212 determines whether the security mode used in the infrastructure connection is “WPA2 mode”. The CPU 212 makes this determination based on the information pertaining to the security mode used in the infrastructure connection obtained in step S1306. If the CPU 212 determines that the mode is “WPA2 mode”, the sequence moves to step S1315. However, if the CPU 212 determines that the mode is not “WPA2 mode”, the sequence moves to step S1309.

In step S1309, the CPU 212 determines whether the MFP 100 has made an infrastructure connection in the past (whether a connection record is present). If the CPU 212 determines that an infrastructure connection has been made in the past, the sequence moves to step S1310. However, if the CPU 212 determines that an infrastructure connection has not been made in the past, the sequence moves to step S1311. Specifically, as described above, when the MFP 100 makes an infrastructure connection, the CPU 212 stores information pertaining to the external AP in the RAM 214 and the non-volatile memory 215. The information pertaining to the external AP includes information pertaining to the security mode. In step S1309, the CPU 212 determines whether information pertaining to the security mode used by the MFP 100 in a past infrastructure connection is stored. In other words, in step S1309, the CPU 212 determines whether a connection history of infrastructure connections is stored.

In step S1310, the CPU 212 refers to (obtains) information pertaining to the security mode used when the MFP 100 made an infrastructure connection in the past from the RAM 214 and the non-volatile memory 215. The CPU 212 then determines the operating version of the wireless unit 226 based on the obtained information pertaining to the security mode. Specifically, the CPU 212 determines whether the information pertaining to the security mode used when the MFP 100 made an infrastructure connection in the past is information indicating WPA3 mode. If the CPU 212 determines that the information indicates WPA3 mode, for example, the operating version of the wireless unit 226 is determined to be “R2”. However, if the CPU 212 determines that the information does not indicate WPA3 mode, for example, the operating version of the wireless unit 226 is determined to be “R1”.

In step S1311, the CPU 212 displays a screen for selecting the operating version of the wireless unit 226 in the console unit 220. Here, the description will refer to FIG. 8C. FIG. 8C illustrates an example of a selection screen 820 displayed by the CPU 212 in the console unit 220 in step S1311. An “R2” button 821 and an “R1” button 822 are displayed in the selection screen 820. The button 821 is an acceptance button capable of accepting a user instruction to cause the wireless unit 226 to execute the second connection processing. The button 822 is an acceptance button capable of accepting a user instruction to cause the wireless unit 226 to execute the first connection processing. In step S1311, the CPU 212 accepts, through the selection screen 820, a user selection as to which of the first connection processing or the second connection processing the wireless unit 226 is to be caused to perform. The CPU 212 then determines, based on the user operation (user selection) in the selection screen 820, whether to cause the wireless unit 226 to perform the first connection processing or the second connection processing. In other words, if the button 821 is pressed, the CPU 212 determines the operating version of the wireless unit 226 to be “R2”. However, if the button 822 is pressed, the CPU 212 determines the operating version of the wireless unit 226 to be “R1”.

In step S1312, the CPU 212 determines whether the operating version determined in step S1310 or step S1311 is “R2”. If the CPU 212 determines that the version is “R2”, the sequence moves to step S1313. However, if the CPU 212 determines that the setting is not “R2”, the sequence moves to step S1315.

The processing of steps S1313 to S1322 is the same as that of steps S1108 to S1117 in FIGS. 11A and 11B, and will therefore not be described here.

As described thus far, according to the present embodiment, if the MFP 100 is not in an infrastructure connection (NO in step S1304), the CPU 212 moves the sequence to step S1309, where information pertaining to the security mode used in a past infrastructure connection is obtained. Then, if the information pertaining to the security mode used in a past infrastructure connection is information indicating WPA3 mode, the CPU 212 enables the WFD R2 function. However, if the information pertaining to the security mode used in a past infrastructure connection is not information indicating WPA3 mode, the CPU 212 enables the WFD R1 function. In other words, the CPU 212 then controls the wireless unit 226 to make a direct connection through either the first connection processing or the second connection processing based on the information pertaining to the security mode used by the external AP discovered through the search.

Such a configuration makes it possible to set the appropriate function based on the information pertaining to the security mode used in a past infrastructure connection, even if the MFP 100 is not in an infrastructure connection.

Additionally, in the present embodiment, even if the MFP 100 is in an infrastructure connection, if the security mode used in the infrastructure connection is neither the WPA3 mode nor the WPA2 mode (NO in step S1308), the CPU 212 moves the sequence to step S1309. If the MFP 100 is in an infrastructure connection, the security level of the security mode used in the infrastructure connection may be lower than WPA2 and WPA3. In such a case, the CPU 212 can set a more appropriate function by enabling either the WFD R1 function or the WFD R2 function based on the information pertaining to the security mode used in the past infrastructure connection.

Note that in step S1209 of the second embodiment described above, if the CPU 212 is unable to discover an AP through the search, the operating version of the wireless unit 226 is determined to be “R1”. However, the configuration is not limited thereto. If the CPU 212 is unable to discover the AP through the search in step S1209, the selection screen 820 of FIG. 8C may be displayed in the console unit 220. The CPU 212 may then determine the operating version of the wireless unit 226 based on the user selection received in the selection screen 820.

Note that with respect to the parts of the foregoing descriptions about the processing performed during the reception of print data, similar processing can be applied during the reception of other data different from print data, or during the sending of such other data. For example, the same processing can be applied when scanning a document using the reading unit 219 and sending the scanned image (image data) to the mobile terminal device (104) via an AP.

The above-described various types of control performed by the CPU 212 may be performed by a single piece of hardware, or the control of the apparatus as a whole may be performed by dividing the processing up among multiple pieces of hardware (e.g., multiple processors or circuits).

Although the foregoing embodiments describe as examples cases where an MFP is applied, the embodiments are not limited to this example, and can be applied in any wireless device capable of P2P (WLAN) communication based on a WFD. In other words, the embodiments can be applied in personal computers, PDAs, tablet terminals, mobile telephone terminals such as smartphones, music players, game consoles, e-book readers, smart watches, various measurement devices (sensor devices) such as thermometers and hygrometers, and the like. The embodiments can also be applied in digital cameras (including still cameras, video cameras, network cameras, and security cameras), printers, scanners, and drones. The embodiments can also be applied in video output devices, audio output devices (e.g., smart speakers), streaming media players, wireless LAN client devices (adapters) to which USB terminals, LAN cable terminals, or the like can be connected, and the like. Video output devices include, for example, a device such as a set-top box, which obtains (downloads) a moving image or still image on the Internet, specified by a URL provided by a communication apparatus, and outputs the moving image or still image to a display device connected through a video output terminal such as an HDMI (registered trademark) terminal. Through this, streaming playback, a mirrored display (a display in which content displayed in a communication apparatus is also displayed on a display device), or the like is implemented in a display device. The video output device also includes a media player such as a television, a hard disk recorder, a Blu-ray recorder, a DVD recorder, or the like, as well as a head-mounted display, a projector, a television, a display device (monitor), a signage device, or the like. The embodiment can also be applied in a device capable of connecting through Wi-Fi, or what is known as a “smart home appliance”, such as an air conditioner, a refrigerator, a washing machine, a vacuum cleaner, an oven, a microwave oven, a lighting fixture, a heating appliance, a cooling appliance, or the like.

According to the present disclosure, the convenience when a communication apparatus makes a direct connection with an external device can be improved.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No.2024-208886, filed Nov. 29, 2024 which is hereby incorporated by reference herein in its entirety.

What is claimed is:

1. A communication apparatus comprising:
at least one memory and at least one processor which function as:
an infrastructure connection unit configured to make an infrastructure connection with an external device through an external access point;
a direct connection unit configured to make a direct connection with an external device without going through an external access point;
a first obtainment unit configured to obtain information pertaining to a security mode used in the infrastructure connection made by the infrastructure connection unit; and
a control unit configured to control the direct connection unit to make the direct connection based on the information pertaining to the security mode obtained by the first obtainment unit,
wherein connection processing for the direct connection includes first connection processing corresponding to a first security mode and second connection processing corresponding to a second security mode having a security level higher than a security level of the first security mode, and
the control unit controls the direct connection unit to perform one of the first connection processing and the second connection processing based on the information pertaining to the security mode obtained by the first obtainment unit.

2. The communication apparatus according to claim 1,
wherein the control unit controls the direct connection unit to perform the second connection processing in a case where the information pertaining to the security mode obtained by the first obtainment unit is information indicating the second security mode.

3. The communication apparatus according to claim 1,
wherein the control unit controls the direct connection unit to perform the first connection processing in a case where the information pertaining to the security mode obtained by the first obtainment unit is information indicating the first security mode.

4. The communication apparatus according to claim 1,
wherein the at least one memory and the at least one processor further function as:
a first acceptance unit configured to accept a first user instruction for causing the direct connection unit to perform one of the first connection processing and the second connection processing based on the information pertaining to the security mode obtained by the first obtainment unit, and
in a case where the first user instruction is accepted by the first acceptance unit, the control unit controls the direct connection unit to perform one of the first connection processing and the second connection processing based on the information pertaining to the security mode accepted by the first obtainment unit.

5. The communication apparatus according to claim 4,
wherein the at least one memory and the at least one processor further function as:
a second acceptance unit configured to accept a second user instruction for causing the direct connection unit to perform the first connection processing regardless of information pertaining to the security mode used in the infrastructure connection made by the infrastructure connection unit, and
in a case where the second user instruction is accepted by the second acceptance unit, the control unit controls the direct connection unit to perform the first connection processing.

6. The communication apparatus according to claim 4,
wherein the at least one memory and the at least one processor further function as:
a third acceptance unit configured to accept a third user instruction for causing the direct connection unit to perform the second connection processing regardless of information pertaining to the security mode used in the infrastructure connection made by the infrastructure connection unit, and
in a case where the third user instruction is accepted by the third acceptance unit, the control unit controls the direct connection unit to perform the second connection processing.

7. The communication apparatus according to claim 4,
wherein the at least one memory and the at least one processor further function as:
a notification unit configured to notify a user as to which of the first connection processing and the second connection processing is to be performed by the direct connection unit, in a case where the first user instruction is accepted by the first acceptance unit.

8. The communication apparatus according to claim 1,
wherein the at least one memory and the at least one processor further function as:
a search unit configured to search for a surrounding external access point in a case where the information pertaining to the security mode obtained by the first obtainment unit is information indicating a third security mode different from both the first security mode and the second security mode, and
in a case where the information pertaining to the security mode obtained by the first obtainment unit is information indicating the third security mode, the control unit controls the direct connection unit to perform one of the first connection processing and the second connection processing based on information pertaining to a security mode used by an external access point discovered by the search unit.

9. The communication apparatus according to claim 1,
wherein the at least one memory and the at least one processor further function as:
a second obtainment unit configured to obtain, from a storage unit, information pertaining to a security mode used in a past infrastructure connection, in a case where the information pertaining to the security mode obtained by the first obtainment unit is information indicating a third security mode different from both the first security mode and the second security mode, and
in a case where the information pertaining to the security mode obtained by the first obtainment unit is information indicating the third security mode, the control unit controls the direct connection unit to perform one of the first connection processing and the second connection processing based on the information pertaining to the security mode used in the past infrastructure connection in the past, obtained by the second obtainment unit.

10. The communication apparatus according to claim 9,
wherein the at least one memory and the at least one processor further function as:
a fourth acceptance unit configured to accept a user selection as to which of the first connection processing and the second connection processing the direct connection unit is to perform, in a case where the information pertaining to the security mode used in the past infrastructure connection is not stored in the storage unit, and
the control unit controls the direct connection unit to perform one of the first connection processing and the second connection processing based on the user selection accepted by the fourth acceptance unit.

11. The communication apparatus according to claim 1,
wherein in a case where the infrastructure connection has not been made by the infrastructure connection unit, the control unit controls the direct connection unit to perform the first connection processing.

12. The communication apparatus according to claim 1,
wherein the at least one memory and the at least one processor further function as:
a search unit configured to search for a surrounding external access point in a case where the infrastructure connection has not been made by the infrastructure connection unit, and
in a case where the infrastructure connection has not been made by the infrastructure connection unit, the control unit controls the direct connection unit to perform one of the first connection processing and the second connection processing based on information pertaining to a security mode used by an external access point discovered by the search unit.

13. The communication apparatus according to claim 1,
wherein the at least one memory and the at least one processor further function as:
a second obtainment unit configured to obtain, from a storage unit, information pertaining to a security mode used in a past infrastructure connection, in a case where the infrastructure connection has not been made by the infrastructure connection unit, and
in a case where the infrastructure connection has not been made by the infrastructure connection unit, the control unit controls the direct connection unit to perform one of the first connection processing and the second connection processing based on the information pertaining to the security mode used in the past infrastructure connection, obtained by the second obtainment unit.

14. The communication apparatus according to claim 13,
wherein the at least one memory and the at least one processor further function as:
a fourth acceptance unit configured to accept a user selection as to which of the first connection processing and the second connection processing the direct connection unit is to perform, in a case where the information pertaining to the security mode used in the past infrastructure connection is not stored in the storage unit, and
the control unit controls the direct connection unit to perform one of the first connection processing and the second connection processing based on the user selection accepted by the fourth acceptance unit.

15. The communication apparatus according to claim 1,
wherein the first connection processing is processing compliant with a first standard of Wi-Fi Direct, and
the second connection processing is processing compliant with a second standard of Wi-Fi Direct published later than the first standard.

16. The communication apparatus according to claim 1,
wherein the first security mode is Wi-Fi Protected Access (WPA) 2, and
the second security mode is WPA3.

17. The communication apparatus according to claim 1,
wherein the communication apparatus is a printer.

18. A control method for a communication apparatus,
the communication apparatus including
an infrastructure connection unit configured to make an infrastructure connection with an external device through an external access point, and
a direct connection unit configured to make a direct connection with an external device without going through an external access point,
the control method comprising:
obtaining information pertaining to a security mode used in the infrastructure connection made by the infrastructure connection unit; and
controlling the direct connection unit to make the direct connection based on the information pertaining to the security mode obtained in the obtaining,
wherein connection processing for the direct connection includes first connection processing corresponding to a first security mode and second connection processing corresponding to a second security mode having a security level higher than a security level of the first security mode, and
in the controlling, the direct connection unit is controlled to perform one of the first connection processing and the second connection processing based on the information pertaining to the security mode obtained in the obtaining.

19. A non-transitory computer-readable storage medium storing a program configured to cause a computer of a communication apparatus to function as:
an infrastructure connection unit configured to make an infrastructure connection with an external device through an external access point;
a direct connection unit configured to make a direct connection with an external device without going through an external access point;
a first obtainment unit configured to obtain information pertaining to a security mode used in the infrastructure connection made by the infrastructure connection unit; and
a control unit configured to control the direct connection unit to make the direct connection based on the information pertaining to the security mode obtained by the first obtainment unit,
wherein connection processing for the direct connection includes first connection processing corresponding to a first security mode and second connection processing corresponding to a second security mode having a security level higher than a security level of the first security mode, and
the control unit controls the direct connection unit to perform one of the first connection processing and the second connection processing based on the information pertaining to the security mode obtained by the first obtainment unit.
